(19) United States
(12) Patent Application Publication
(10) Pub. No.: US 2008/0172415 A1
(43) Pub. Date: Jul. 17, 2008

(54) System and method of matching candidates and employers

(76) Inventors: Mark M. Fakhari, Falls Church, VA (US); Manoj Ramnani, Falls Church, VA (US)

Correspondence Address: LITMAN LAW OFFICES, LTD., P.O. BOX 15035, CRYSTAL CITY STATION, ARLINGTON, VA, 22215, US

(21) Appl. No.: 11/652,521

(22) Filed: Jan. 12, 2007

(51) Int. Cl. G06F 17/00

(52) U.S. Cl. 707/104.1

(57) ABSTRACT

The system and method of matching candidates and employers provides a user interface that requires job candidates to enter profile data to a database. The system imposes on the candidate, skills data entry and ranking from predefined lists of technical skills and soft skills. A background check authorization option is provided. The system accepts employer open job profile data that includes job titles, technical skills, soft skills, special requirements, education, certification, security clearance requirements, keywords and background check requirements. Candidate skills and experience profile data are utilized by a matching engine that processes all candidate and open job profiles. Match scores are generated by a unique matching logic to identify candidates with the best fit for a particular job opening. Candidates can only view job openings for which they are selected as top candidates. Employers can only view profiles of candidates who have authorized them to do so.

### BACKGROUND OF THE INVENTION

1. Field of the Invention

The present invention relates to a computerized system for connecting employers and job seekers, and particularly to a system and method of matching candidates and employers.

2. Description of the Related Art

An employment system is any electronic system that facilitates those looking for a position (i.e., job candidates) in finding a position and/or that facilitates those seeking to fill a position (i.e., employers) in finding someone to fill the position. The use of employment systems of a variety of designs and configurations is known in the prior art. More specifically, previously devised employment systems utilized for the purpose of matching employers and job candidates are generally implemented through established computer software methods and consist basically of familiar, expected, and obvious structural configurations, notwithstanding the myriad of designs encompassed by the crowded prior art that has been developed for the fulfillment of countless objectives and requirements. For example, employment systems of the type disclosed in International Patent No. WO 01/84345, published Nov. 8, 2001, are described within a system that automatically matches a job offer with a plurality of profiles. Moreover, employment systems, as of the type disclosed in Japanese Patent No. 2002-24,459, published Jan. 25, 2002, are described within a system that provides a job information register, automatic job matching part and portable telephone.

Although the aforementioned patents describe employer/employee matching systems the patents do not appear to disclose the specific configurations contemplated by the present invention.

Typical employment systems and their associated computer implemented methods provide websites that allow job seekers to view job descriptions and adjust their resume or profile information to match the requirements of a job they have targeted. Job seekers typically appreciate this feature and the opportunity it provides to increase their chances of success. However, from an employer's perspective, a problem arises in that this feature represents a weakness in the system. If all job seekers were completely honest in presenting their qualifications there would be no harm. However, too often, job seekers exploit the weakness by submitting resumes or profiles that represent what the employer is seeking and that exaggerate or misrepresent their skills, capabilities and/or experiences. The problem remains that the employer's identity, as well as job skills required or desired by the employer are revealed to job applicants, thus enabling applicants to tailor their profiles and resumes to “game” the system in order to achieve a job match with the employer that has posted its available positions.

Further, if a potential employer finds a resume that appears ideal, the first indication the employer may receive that information in the resume is inaccurate is when the employer contacts or interviews the job seeker, or even after the job seeker is hired. By the time the potential employer discovers the inaccuracy, considerable time and effort has been wasted.

In employment systems in which potential employers post available positions, potential employers are often inundated with resumes from unqualified job seekers. Some job seekers submit their resume to any position they find desirable, regardless of whether they meet any specified required qualifications on the hope that they will either be the most qualified applicant or that they will be qualified enough to get an interview and perhaps gain employment as a result.

Another problem of many employment systems is that their web sites expose a job seeker's personal information to potential employers, as well as less scrupulous parties in the business of identity theft. Today, identity theft is a huge concern and issue for candidates searching for new job opportunities, since their resumes and personal contact information may be readily available to others.

Additionally, of concern is the fact that while many existing employment-related web sites offer credit and background checks as an added service to both employers and job seekers, these sites make no effort to verify the information provided by the job seekers in their resumes and profiles. Often employers make hiring decisions based on the information in the candidate's resume or profile only to find out that the information was not accurate.

In some related art systems that have questionnaires to weed out candidates, the candidates are generally allowed to answer the questionnaires in any manner. For example, candidates in existing job matching systems can select and rank themselves as having mastered all skills presented in the questionnaire. Thus, a problem arises in that employers may be misled by skewed questionnaire results associated with a given candidate.

Additional difficulties in current employment systems are encountered when unskilled candidates clog up precious information technology resources by submitting garbage resumes, and the like. Moreover, some systems currently in use require voluminous amounts of data in their questionnaires, thus leading a desirable candidate to give up filling out the required form(s).

None of the above inventions and patents, taken either singly or in combination, is seen to describe the instant invention as claimed. Thus, a system and method of matching candidates and employers solving the aforementioned problems is desired.

### SUMMARY OF THE INVENTION

The system and method of matching candidates and employers includes requiring applicants (candidates) to enter profile data into a database. The candidate data entry process starts with the candidate entering personal, contact, and candidate education data. The system imposes on the candidate skills data entry and ranking from predefined lists of technical skills and soft skills. Special candidate requirements are also permitted to be entered via a predefined list into the candidate profiles. Additionally, the candidate can enter, via predefined selection lists, certification information and security clearance information. Moreover, the candidate can select a background check authorization.

The system accepts employer open job profile data entry, detailing required and desired job skills, the data including job titles, technical skills, soft skills, special requirements, education, certification, security clearance requirements, keywords and background check requirements.

The employee candidate profiles, which contain skills and experience data, are utilized by a matching engine having the capability to compare all candidate and open job profiles. The matching engine applies a unique matching logic to identify candidates with the best fit for a particular job opening. Match scores are generated, and candidates can only view job openings for which they are selected as top candidates (e.g., selected as top three candidates). For any of the job candidates, until a match is generated, the candidate cannot view job/employer profile information held by the system. Additionally, no employer can view a job candidate's profile information held by the system until the employer is authorized by the job candidate.

A quality reviewer/analyzer is provided to review and analyze selections generated by the match engine. The reviewer/analyzer has inputs to the match engine that can refine the match-generating processes in order to improve the quality of matching results.

These and other features of the present invention will become readily apparent upon further review of the following specification and drawings.

### BRIEF DESCRIPTION OF THE DRAWINGS

FIG. 1 is a block diagram of a system of matching candidates and employers according to the present invention.

FIG. 2 is a flowchart of a blind application process in a method of matching candidates and employers according to the present invention.

FIG. 3 is a flowchart of a verification process in a method of matching candidates and employers according to the present invention.

FIGS. 4A and 4B are a flowchart of a matching logic for a method of matching candidates and employers according to the present invention.

FIGS. 5A and 5B are a detailed flowchart of the verification process in a method of matching candidates and employers according to the present invention.

FIGS. 6, 7, 8, 9, 10, 11, 12, 13, 14, 15 and 16 are screenshots of a web site capable of implementing the system and method of matching candidates and employers according to the present invention.

FIG. 17 shows a posting detail screenshot utilized by the system and method of matching candidates and employers according to the present invention.

FIGS. 18A and 18B are a flowchart showing a candidate template utilized by the system and method of matching candidates and employers according to the present invention.

FIGS. 19, 20, 21, 22A, 22B, 23, 24, 25, 26, 27, 28, 29 and 30 are additional screen shots of the web site utilizing the system and method of matching candidates and employers according to the present invention.

FIG. 31 is a flowchart of the hire confirmation and awards process in a method of matching candidates and employers according to the present invention.

FIG. 32 is an exemplary Candidate Verification Report provided by the system and method of matching candidates and employers according to the present invention.

Similar reference characters denote corresponding features consistently throughout the attached drawings.

### DETAILED DESCRIPTION OF THE PREFERRED EMBODIMENT

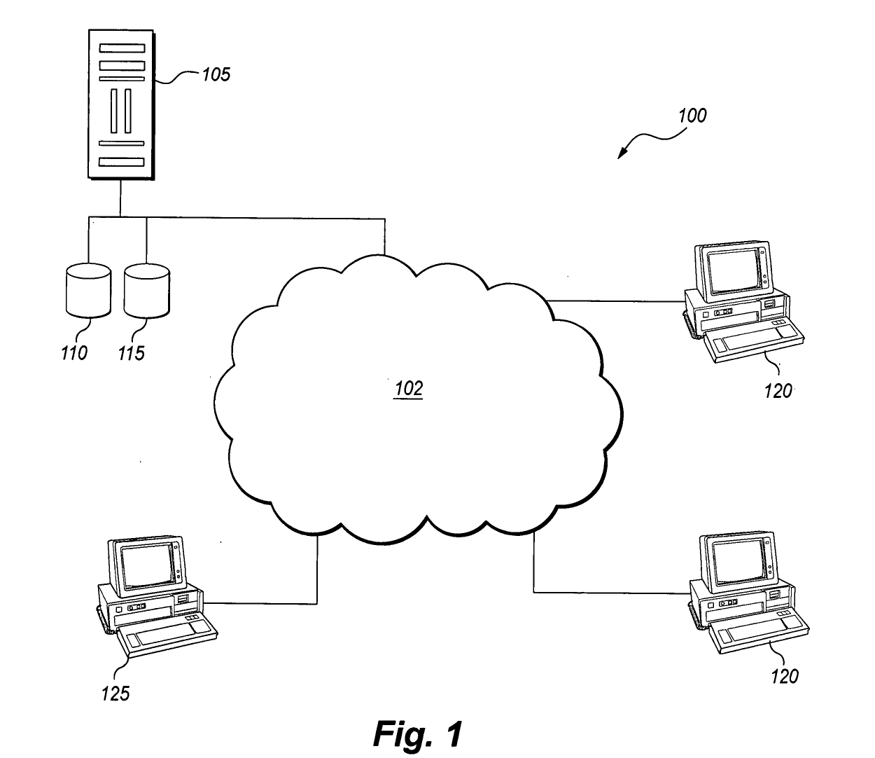

The present invention is an employment matching system and method that can be implemented in a computing environment, such as the system shown in FIG. 1. At least one server 105 is in operable communication with candidate profile data storage unit 110 and open job profile data storage unit 115. The server 105 is also connected to a wide area network (WAN) 102, e.g., the Internet, for presentation of an interface for candidate and employer users via web page(s) on a web site. Job candidate computing devices 120 and employer computing device 125 are also connected to the WAN 102 in order to communicate as clients to server 105. Although not shown, there may be a plurality of employer computing devices 125 as well as the plurality of job candidate computing devices 120.

It is contemplated by the present invention that job candidate computing devices 120 and employer computing device(s) 125 individually have sufficient processing, memory and display resources to transmit information required by server 105 and to adequately respond to, i.e., process and display, information sent to them by server 105. Additionally, it is contemplated by the present invention that the employment matching system and method according to the present invention may be implemented in a variety of computing environments, including, but not limited to, a distributed computing environment, a centralized computing environment, a mobile computing environment, a computing environment that utilizes a kiosk for a user interface, and the like.

Optionally, the system 100 may be configured to communicate on a Local Area Network (LAN), or a combination of LAN and WAN. Additionally, server 105 may be configured to have sufficient processing, memory, communications resources, and the like to host a web server application, a database management application, and programming instructions required to implement the functionality of the present invention.

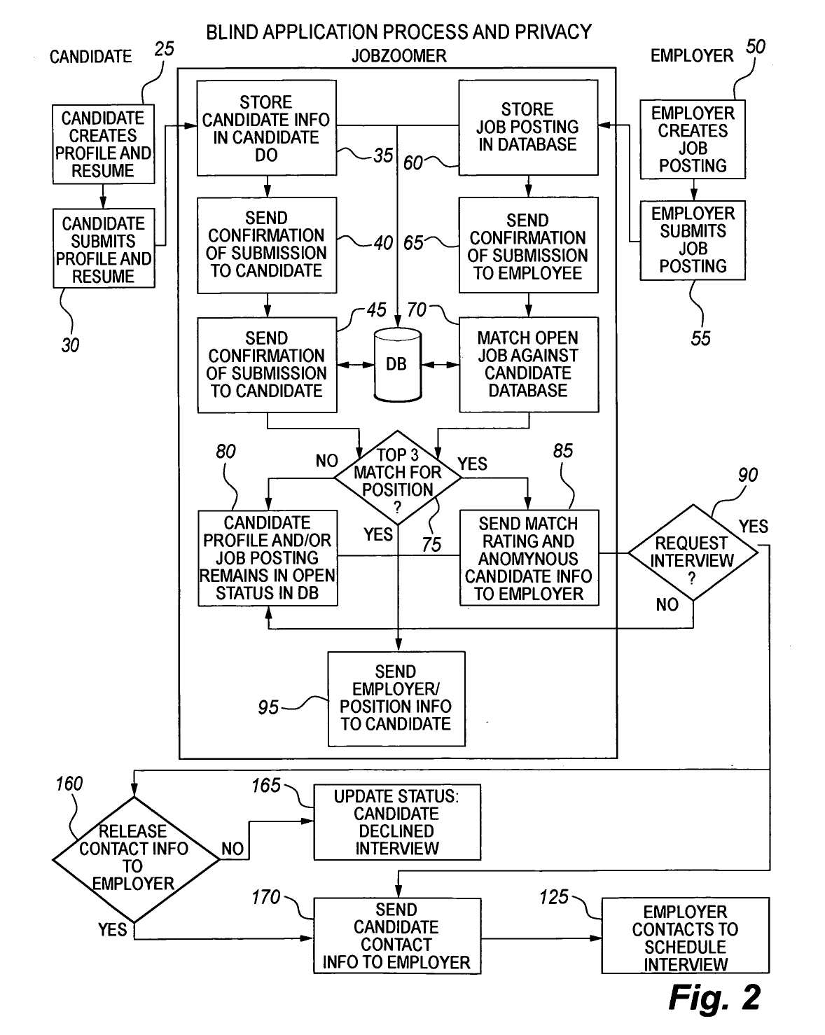

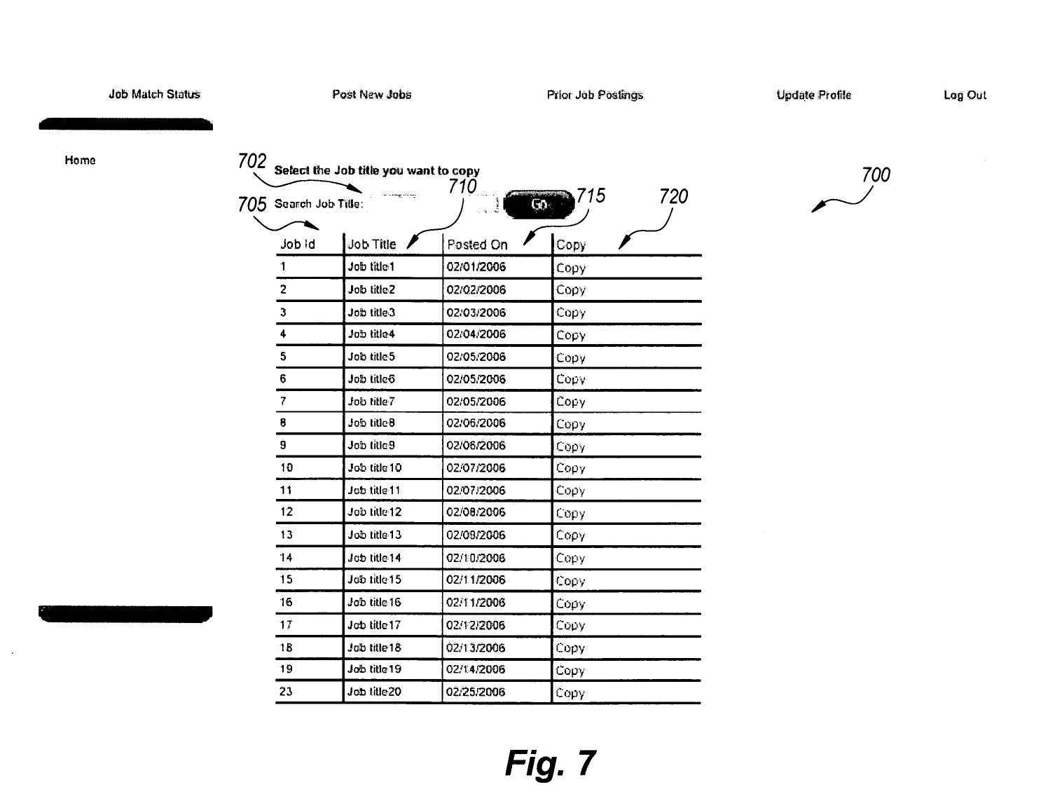

As shown in FIGS. 1-2 and 6-8, the present invention includes a user interface that requires applicants (candidates) to enter profile data to a candidate profile database 110. Referring to FIG. 2, the candidate creates a candidate profile and/or resume at step 25. The candidate can submit the profile and/or resume at step 30. As shown in step 35, the system 100 stores the candidate profile and/or resume in candidate profile database 110. As shown at step 40, the system 100 can send to the candidate confirmation of the candidate submission. Confirmation may be via any communications mode, including, but not limited to, e-mail, voicemail, notification on a web page, and the like.

Similarly, as shown in FIG. 2, step 50, the employer can create a job posting. The system 100 permits the employer to submit the job posting, as shown at step 55. At step 60 the job posting is stored in a job posting, i.e., open jobs database 115. At step 65 a confirmation of the submission is sent to the employer. At step 70, the system 100 performs matching of open jobs against candidate profiles in the candidate profile database 110. At step 45 the system 100 processes a response to the matching step 70. At step 75 the determination is made whether a candidate is in, e.g., the top three matches, for a given job opening. Operators of the system 100 have the capability to configure the top match number to any number, in this case the top three. As shown in step 80, if the top matching number criterion is not met, the candidate profile and/or job opening remain in open status.

As shown at step 85, if the top matching number criterion is met for a candidate, a match rating and anonymous candidate information are sent to the employer. At step 95, employer/job opening information is sent to the candidate. At step 90 if the employer does not request an interview, the candidate status and/or job status remain open. If the employer requests an interview, at step 160, the candidate is given the opportunity to release contact information to the employer. If the candidate chooses not to release the contact information, then, at step 165, the system 100 updates the status to “candidate declined interview”. If the candidate chooses to release the contact information, then, at step 170, the system 100 sends the candidate contact information to the employer. At step 175 the employer can contact the candidate to schedule an interview.

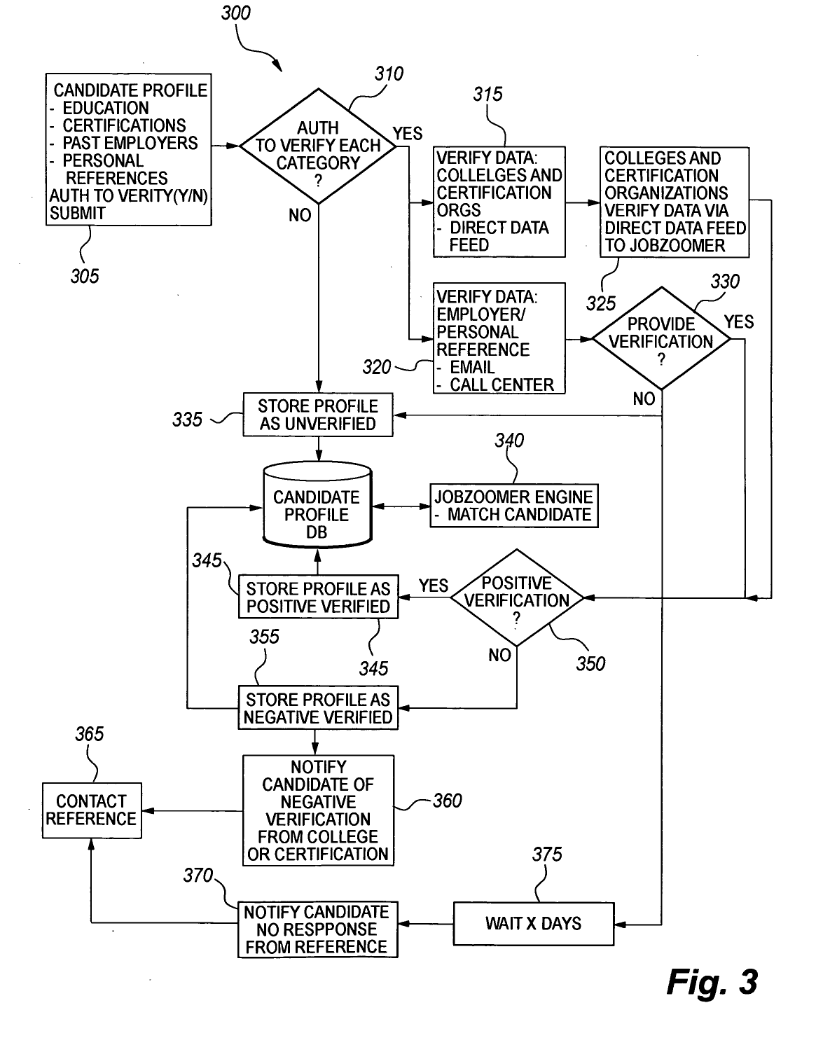

As shown in FIG. 3, the system 100 is capable of performing verification processing 300. At step 310, if candidate information 305 is selected for non-verify, then at step 335 the candidate profile is stored in the candidate profile database 110 as unverified. At step 340, the match engine matches candidates from the candidate profile database. Alternatively, verification steps 315 and 320 are performed to verify colleges, certification organizations, and employer/personal references. Verification steps 315 and 320 may be performed via operable communication with external computing systems, as shown at step 325, and/or via e-mail and call center operations. Once the verification information has been provided at step 330, a positive verification test is performed at step 350. If the positive verification test checks out, the candidate profile is stored in the candidate profile database 110 as positively verified at step 345. Otherwise, the candidate profile is stored as negatively verified in the candidate profile database 110 at step 355, and the candidate is notified at step 360. The reference is also contacted at step 365. A shown at step 375, if, after a predetermined time, a reference has still not provided information about the candidate, the candidate is once again notified at step 370 and the reference is contacted at step 365.

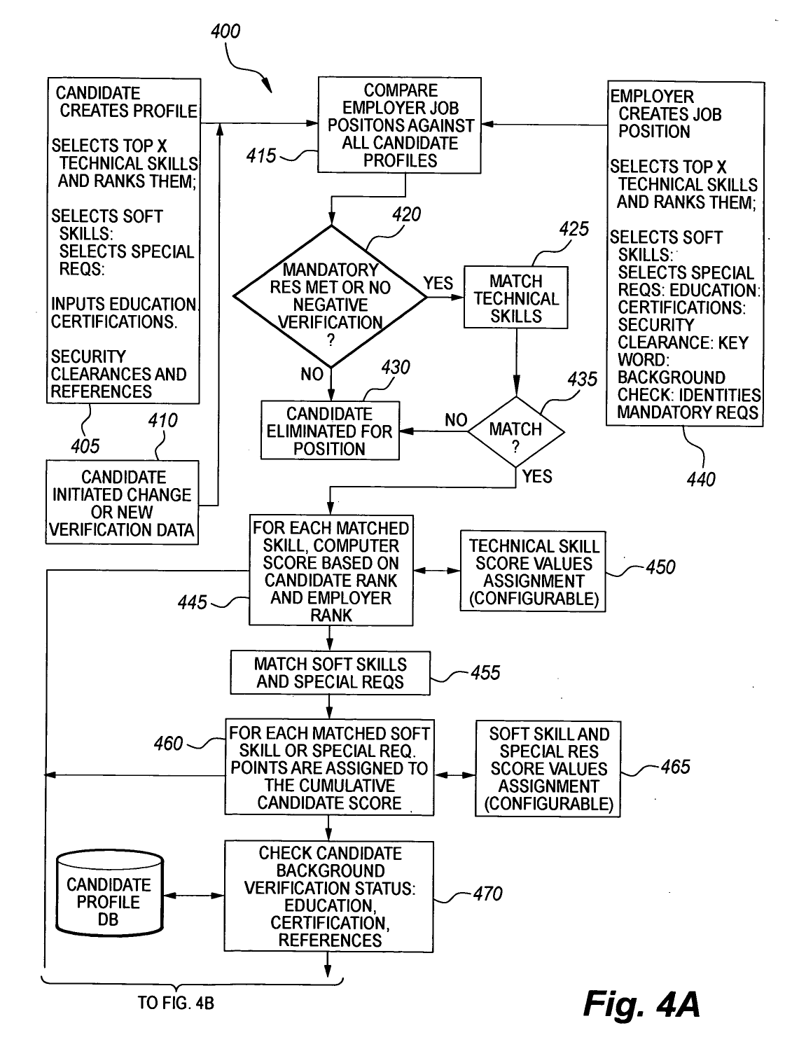

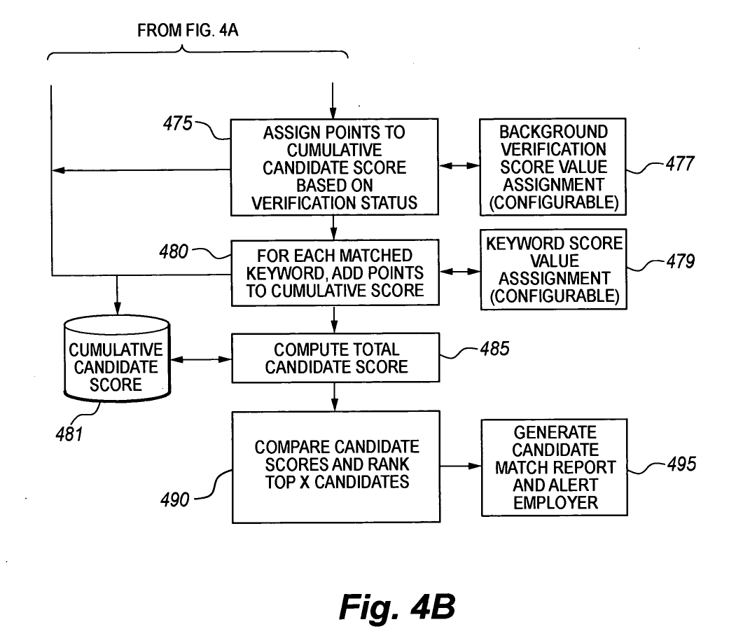

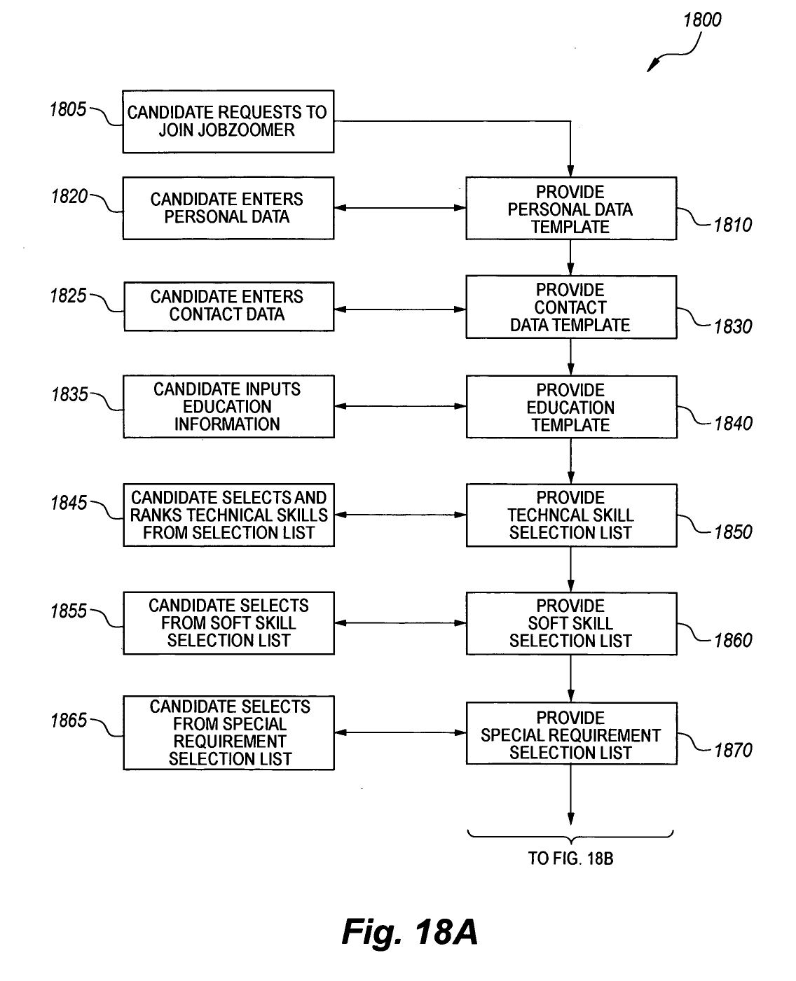

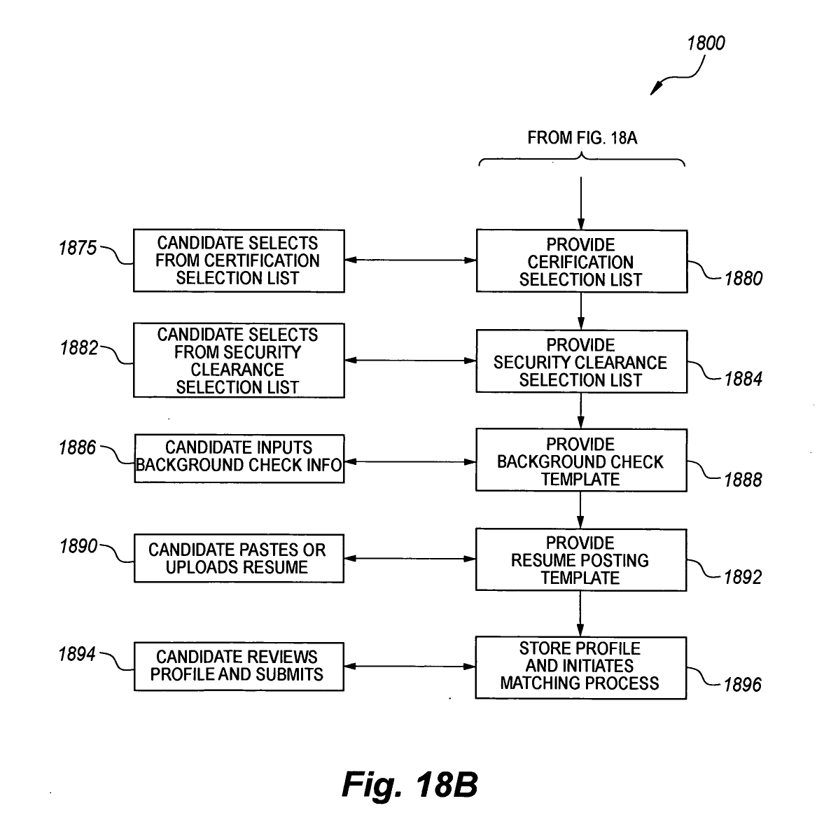

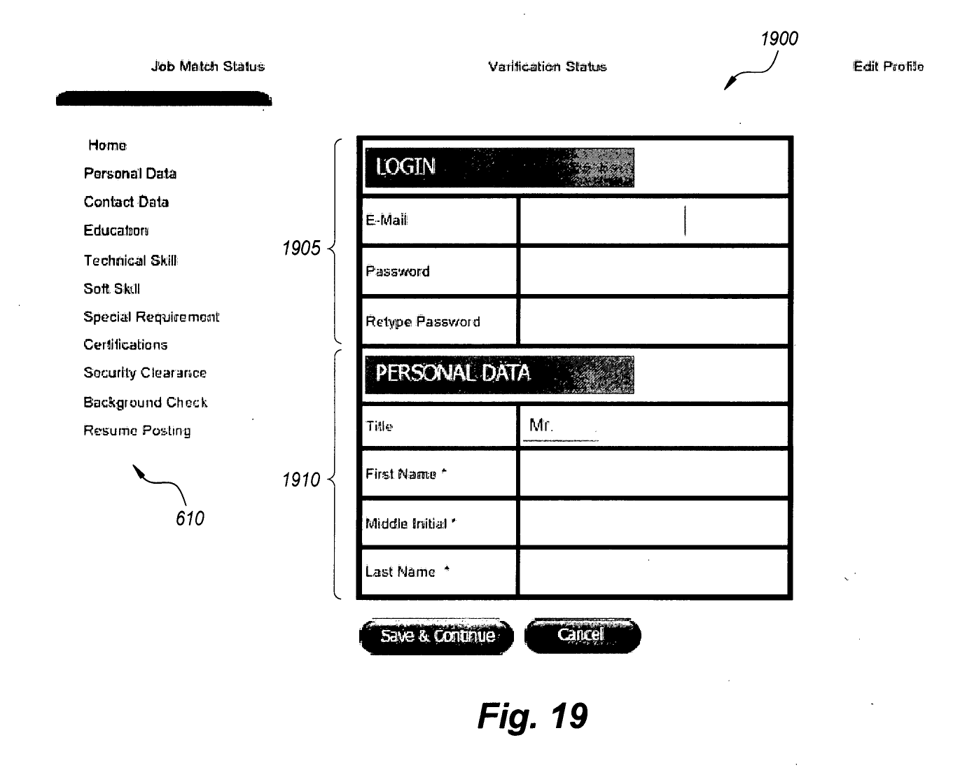

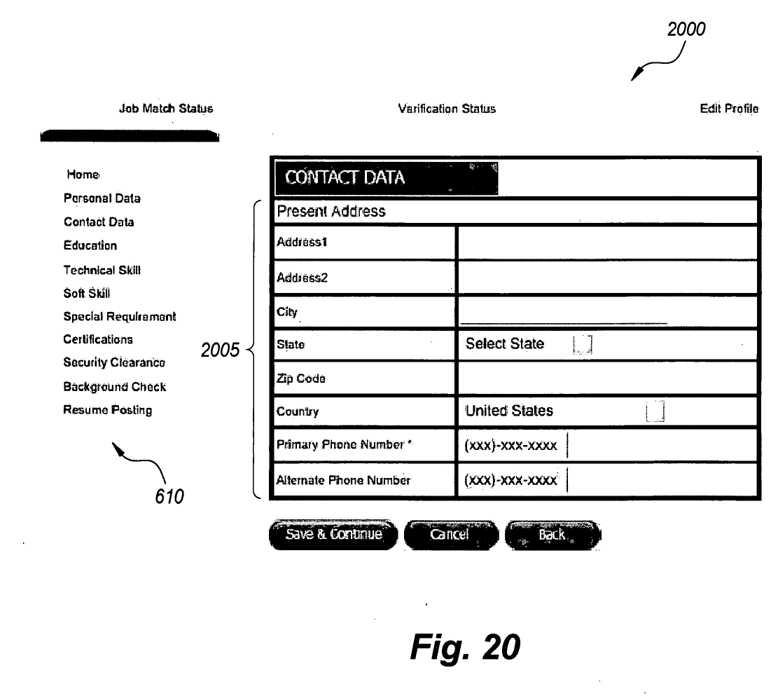

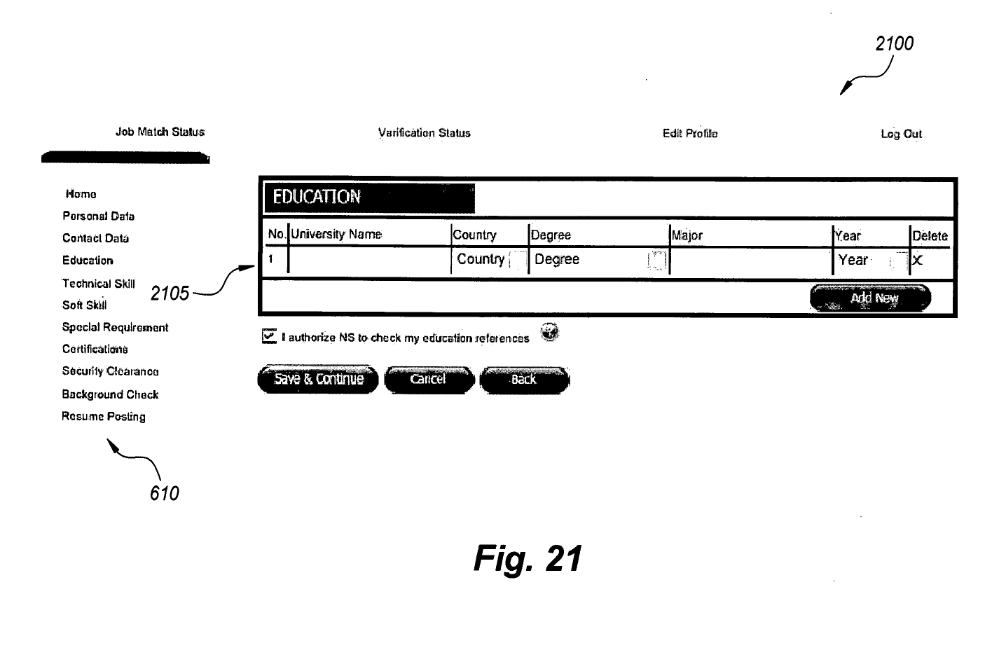

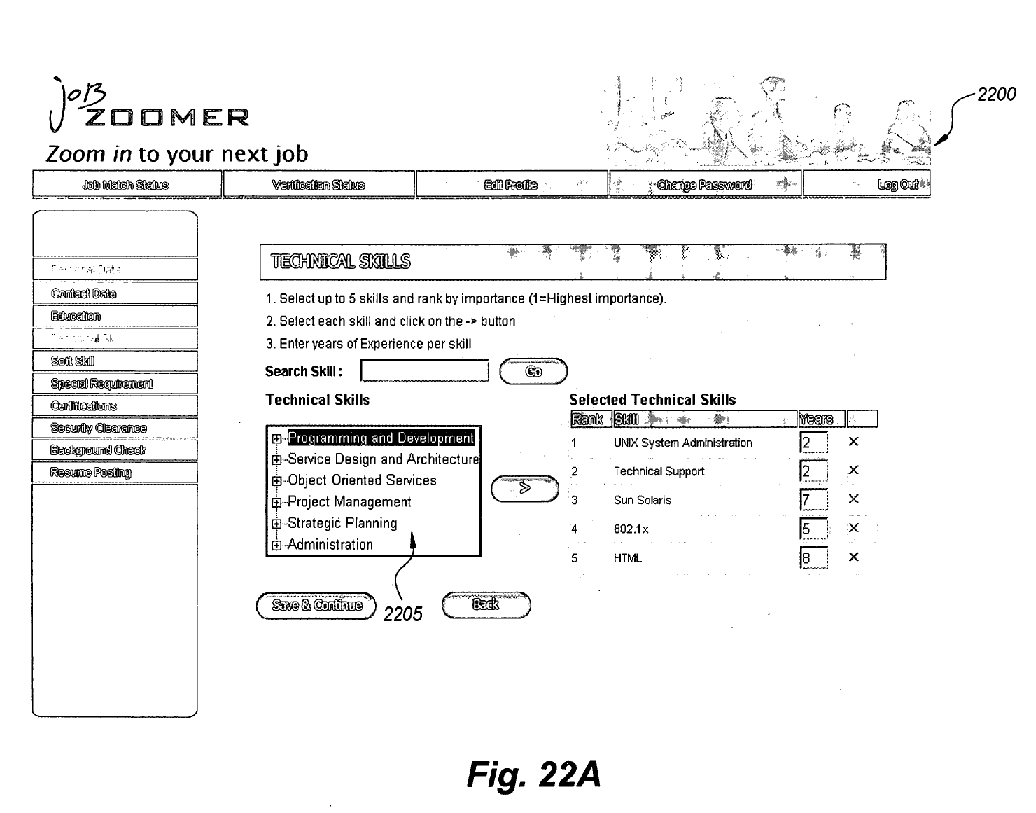

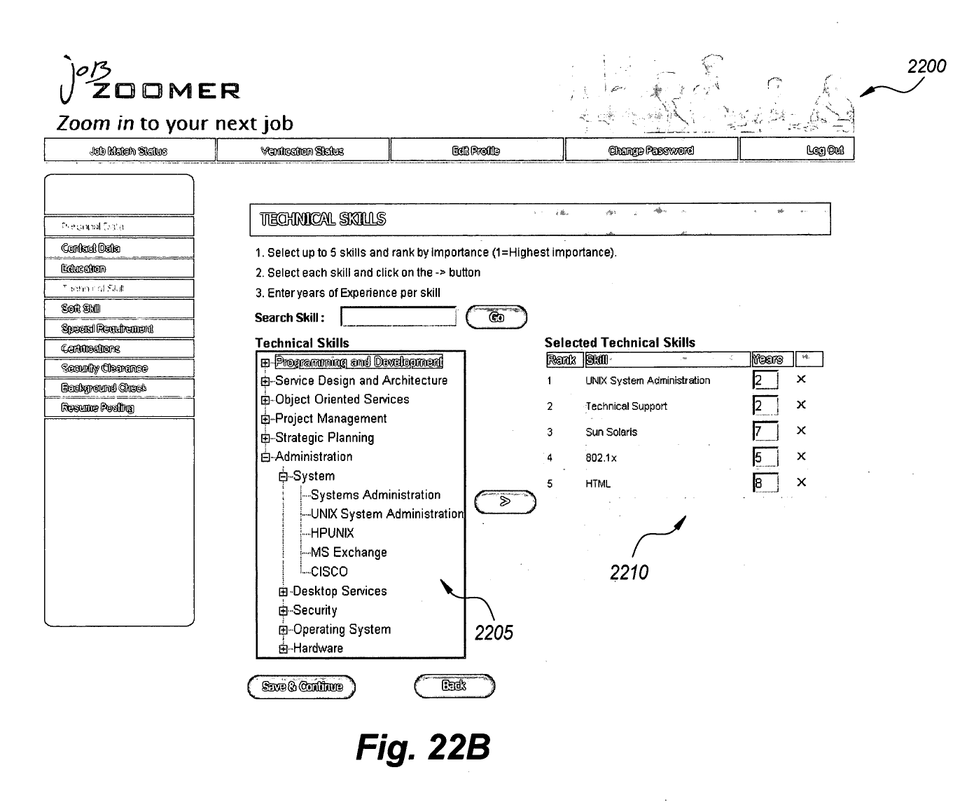

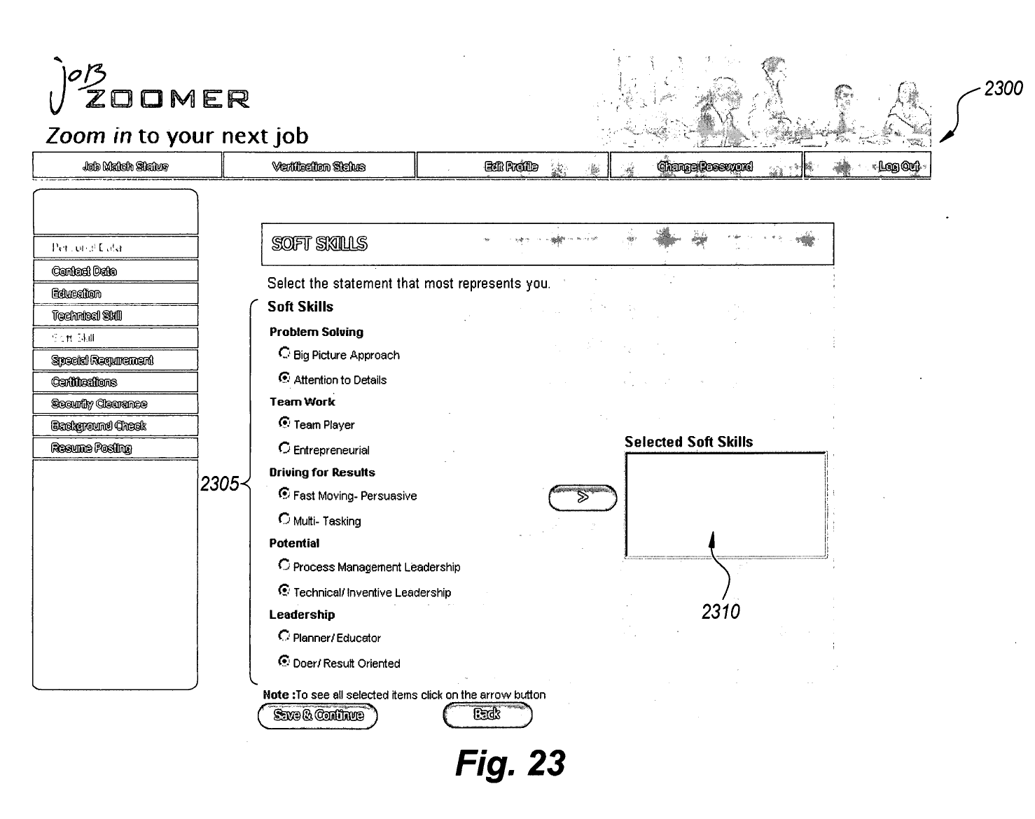

As shown in FIGS. 4A, 4B, 18A-18B, and 19-22B, upon request from the candidate at step 1805, the candidate data entry process 1800 starts with the step 1810 of presenting a personal data template 1900 having candidate login fields 1905 and personal data fields 1910. At step 1820 the candidate enters the personal data. At steps 1825 and 1830, a contact data template 2000 having contact data fields 2005 is presented for entry by the candidate. At steps 1835 and 1840 an education template 2100 is provided for candidate input. The candidate education template data 2105 can be entered in rows by the candidate. At step 405 the candidate creates a profile. As shown at steps 1845-1850, and 1855-1860, the system imposes on the candidate a requirement for skills data entry and ranking from predefined lists of technical skills 2200 (FIGS. 22A-22B) and soft skills 2300 (FIG. 23). The selected skills are ranked according to the order of selection by the candidate.

The technical skills 2200 comprise nested categories of technical skills 2205 from which the candidate may select. For example, as shown in FIG. 22A, the main categories comprise: “Programming and Development”, “Service Design and Architecture”, “Object-Oriented Services”, “Project Management”, “Strategic Planning”, and “Administration”.

The candidate may drill down in subcategories, sub-subcategories, etc., to select a specific technical skill. For example, as shown in FIG. 22B, the “Administration” category has subcategories “System”, “Desktop Services”, “Security”, “Operating System”, and “Hardware”. A candidate who has a system administration background can select “System”, revealing the nested category items “Systems Administration”, “UNIX System Administration”, and “HPUNIX”, from which the candidate may choose as his/her Selected Technical Skill. The candidate's skills selections and rank are displayed in the Selected Technical Skills area 2210.

The soft skills 2300 are derived from groups of declarative statements or phrases that the candidate is directed to select the statement that most represents the candidate. Accordingly, the candidate must select a statement/phrase displayed in screen area 2305 from each of the following areas; “Problem Solving”, “Team Work”, “Driving for Results”, “Potential”, and “Leadership”. The Selected Soft Skills area 2310 can display the soft skills selected by the candidate.

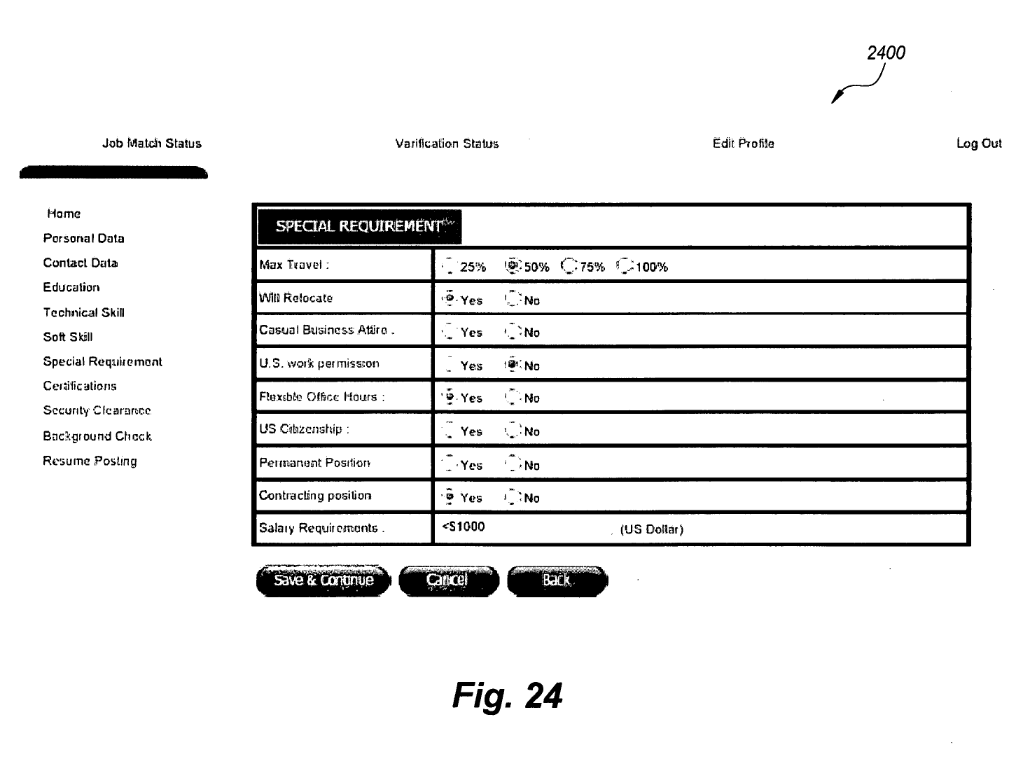

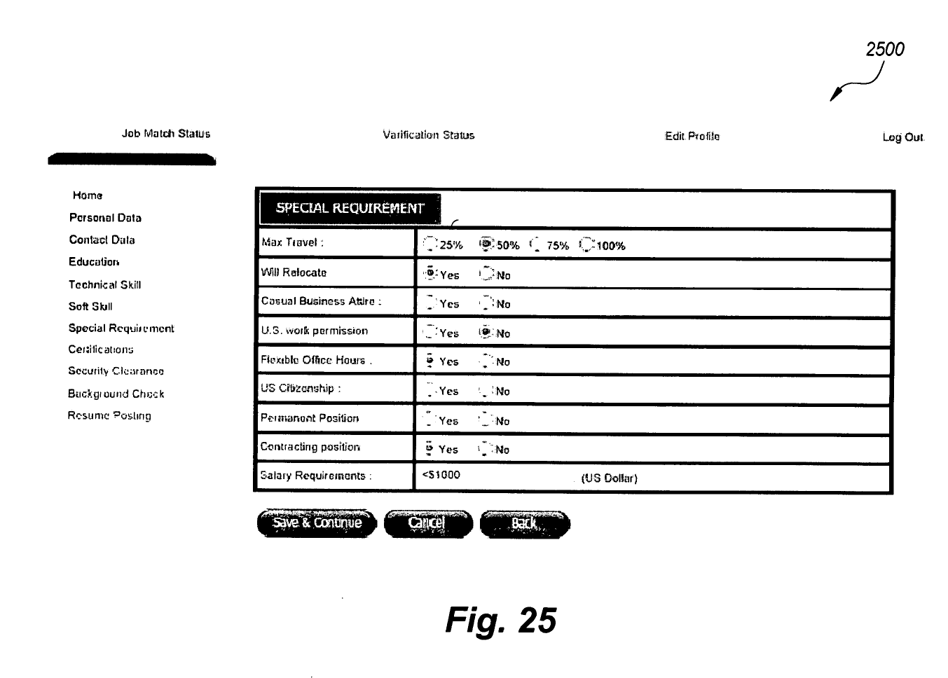

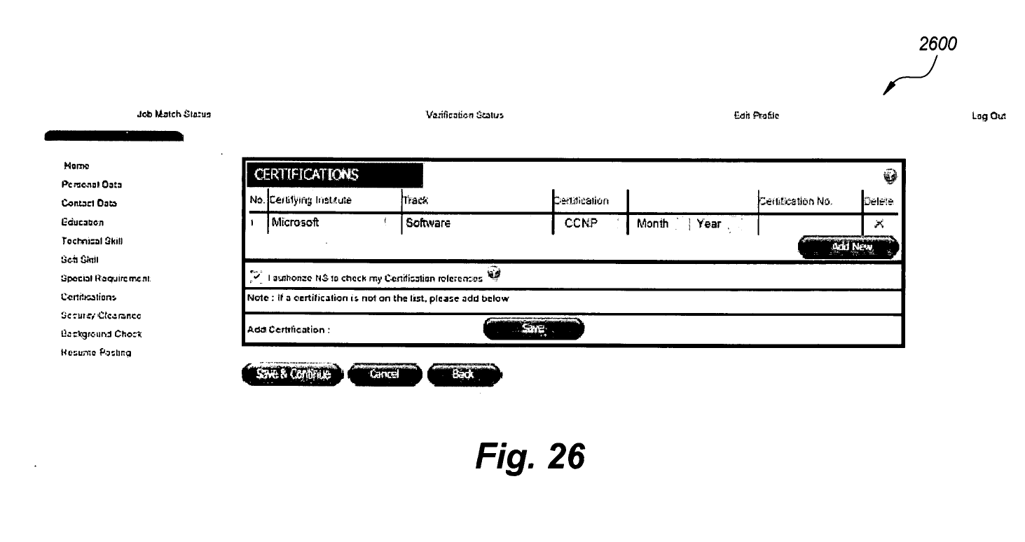

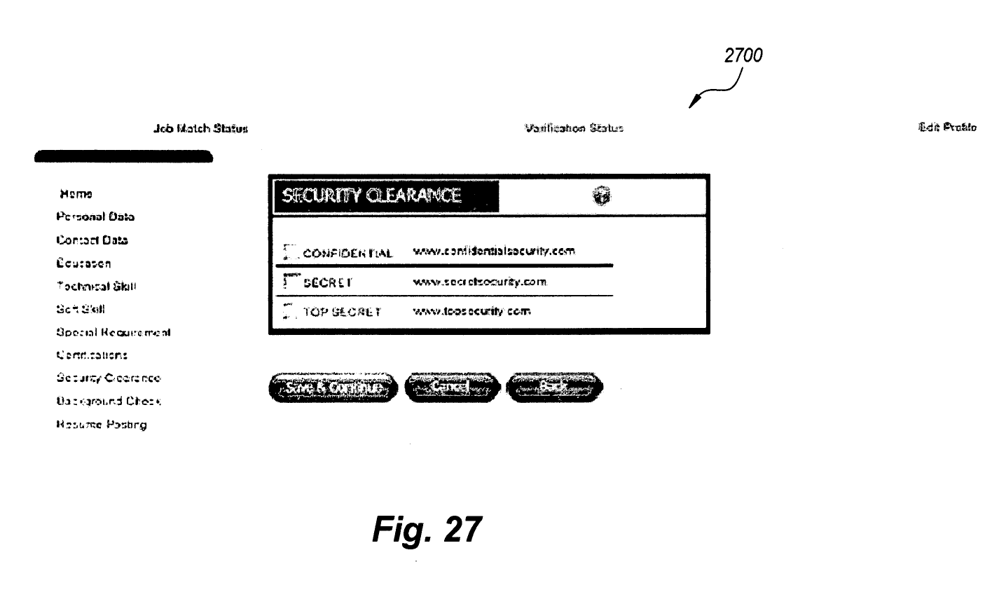

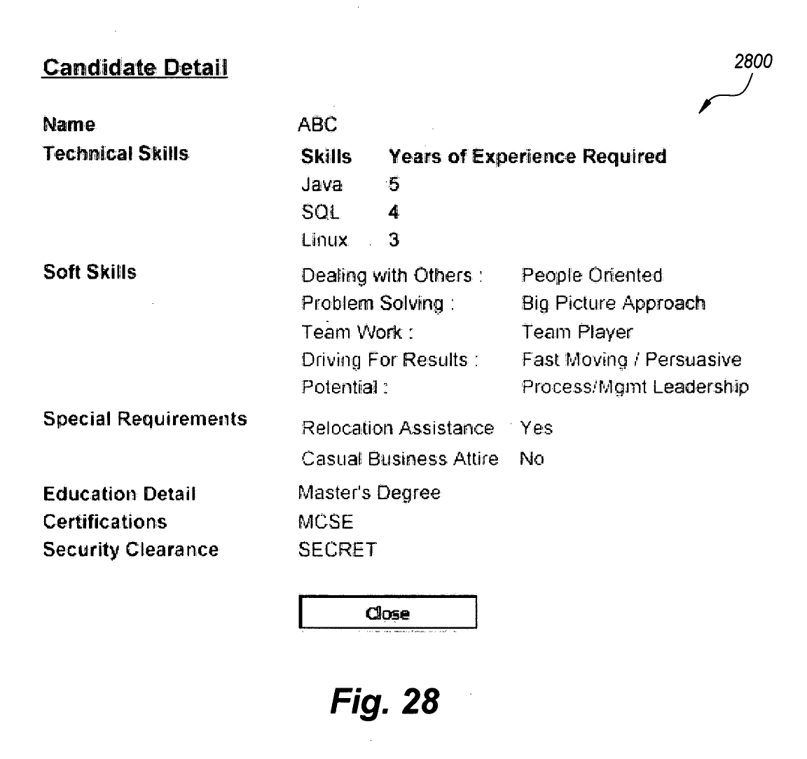

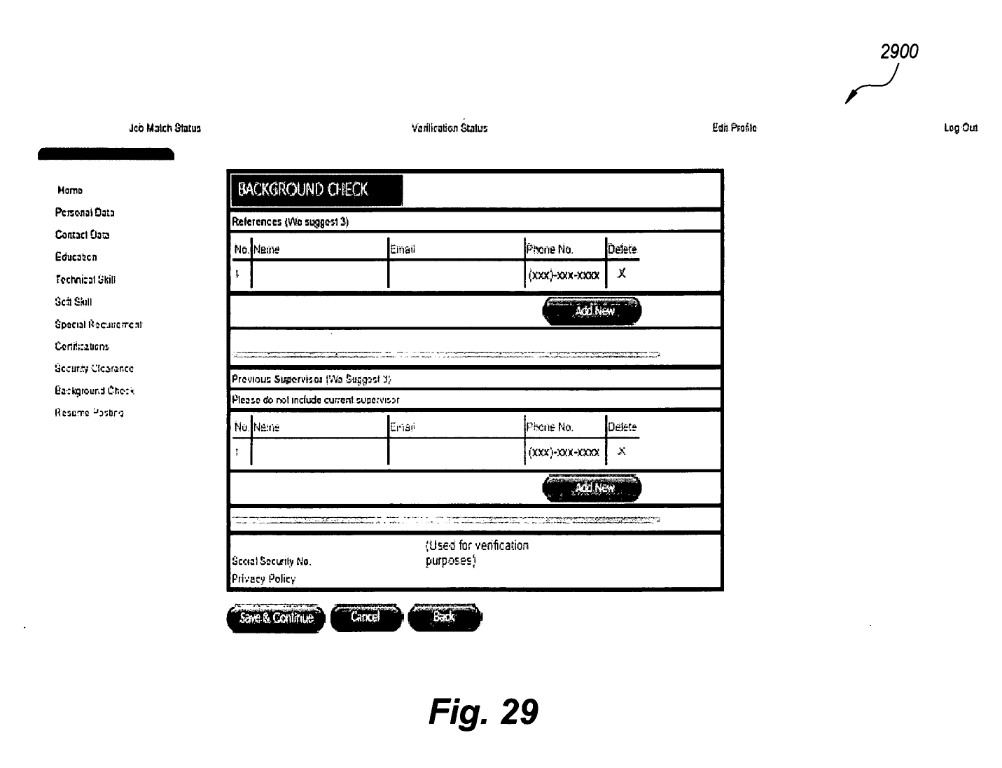

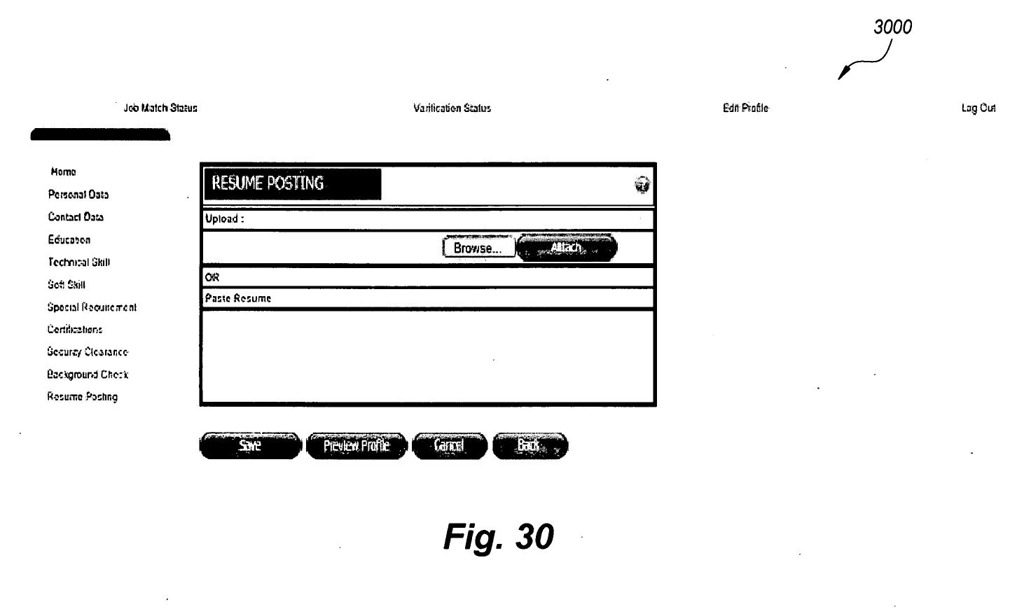

At steps 1865 and 1870 the candidate is provided a special requirement selection list and selects from that list. As shown in FIGS. 24-25, special candidate requirements are also permitted to be entered via the special candidate requirements predefined lists 2400 and 2500 into the candidate profiles. At steps 1875 and 1880 the candidate is provided a certification selection list and selects from that list. At steps 1882 and 1884 the candidate is provided a security clearance selection list and selects from that list. Additionally, as shown in FIGS. 26-27, the candidate can enter via predefined selection lists, certification information 2600, and security clearance information 2700. At steps 1886 and 1888, the candidate is provided a background check template and selects from that template. The background check template 2900 is shown in FIG. 29. At steps 1890 and 1892, the candidate is provided a resume posting template 3000 and uploads or pastes to that template. The resume posting template 3000 is shown in FIG. 30. At steps 1894 and 1896 the candidate can view profile details on a candidate detail page 2800 (FIG. 28) and then submit the profile for storing and match processing by the system 100. It should be understood that preferably the present invention 100 presents to the candidate a set of choices via the aforementioned templates, rather than presenting questions/questionnaires.

Once the candidate has submitted his/her profile, preferably via the web site presented according to the present invention, the system 100 can initiate a series of verification checks on the candidate's profile using e-mail, using a call center, and/or using direct computer feeds into external systems, as described above. Free background checks include personal and professional reference checking, college degree verification, certifications, security clearance status, and previous supervisor inputs.

As is the case with many existing employment related web sites, additional verifications, such as criminal background check, credit/financial history and drug tests, are performed at a cost to the employer. The employer may request that the system 100 perform these verifications prior to continuing processing for a job profile match. Alternatively, the background verifications may be initiated after a job match is made.

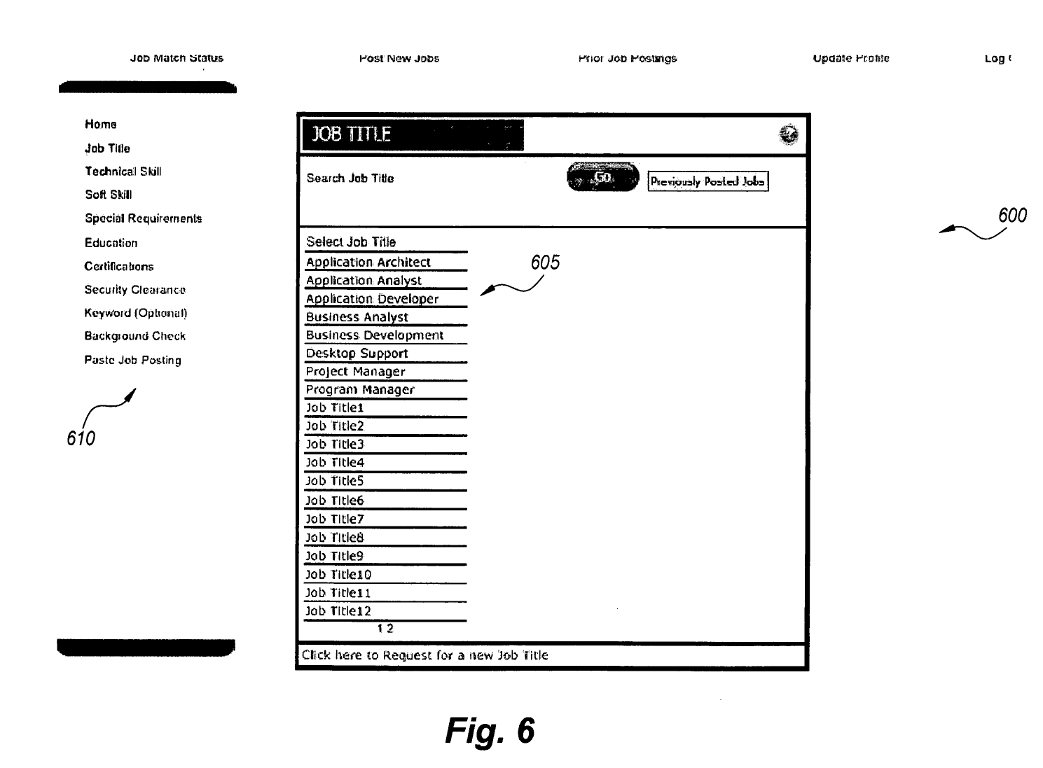

As shown, within system processes 400, at step 440, the system 100 accepts employer open job profile data entry detailing required and desired job skills, the data including job titles, technical skills, soft skills, mandatory requirements, special requirements, education, certification, security clearance requirements, keywords and background check requirements. For example, as shown in FIG. 6, the “Job-Title” category 600 includes a list of job titles 605 tailored for a given market segment (or Domain). Screen area 610 is a link area that can exit the Job Title page 600. Job titles can be copied on the Job Title copy page 700 where a job title can be searched in the search field 702.

Additionally, job IDs are presented in column 705. Job Titles are presented in field column 710. Posting dates are presented in field column 715. The copy action field is presented in column 720.

Examples of domains include Federal IT Contractor Market, System Integrators, HealthCare, Telecom, Internet, Financial, etc. The use of domains and keywords further help to match the candidates correctly.

Once an employer selects a job title, specific templates for that market segment (domain) are provided to guide the employer through the data entry process for each template category in order to create the open job profile for acceptance into open jobs database 115. In a similar manner to the candidate profile entries, the system 100 uses predefined templates for key position requirements entered by the employer to thereby significantly improve search quality, search speed, and ease of use for both the employers and candidates.

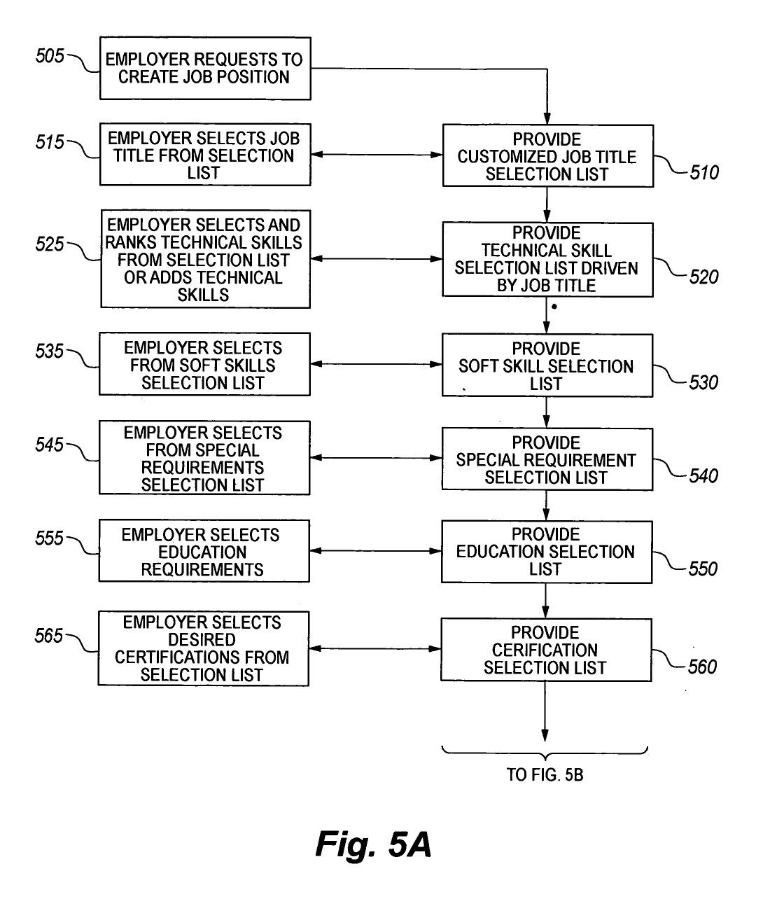

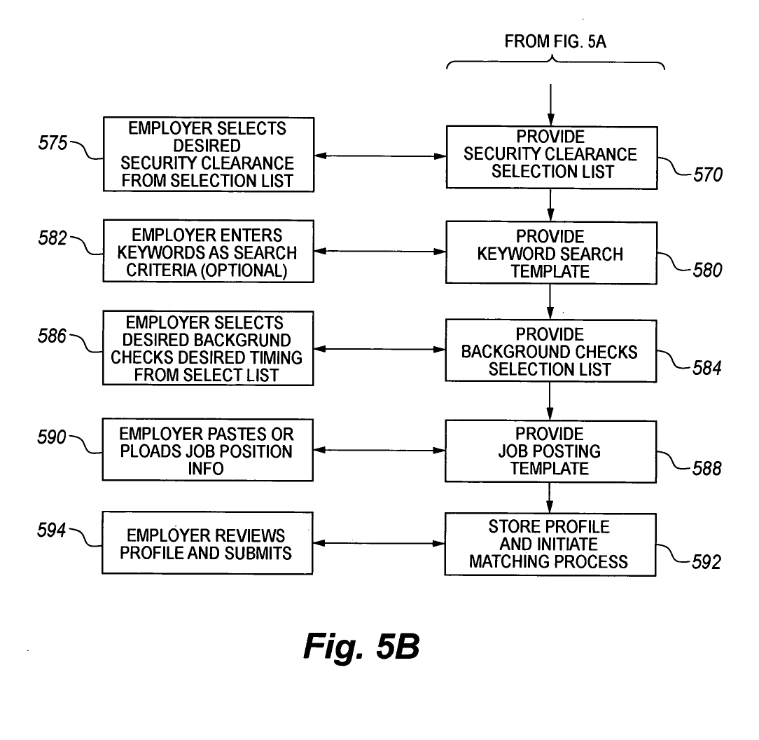

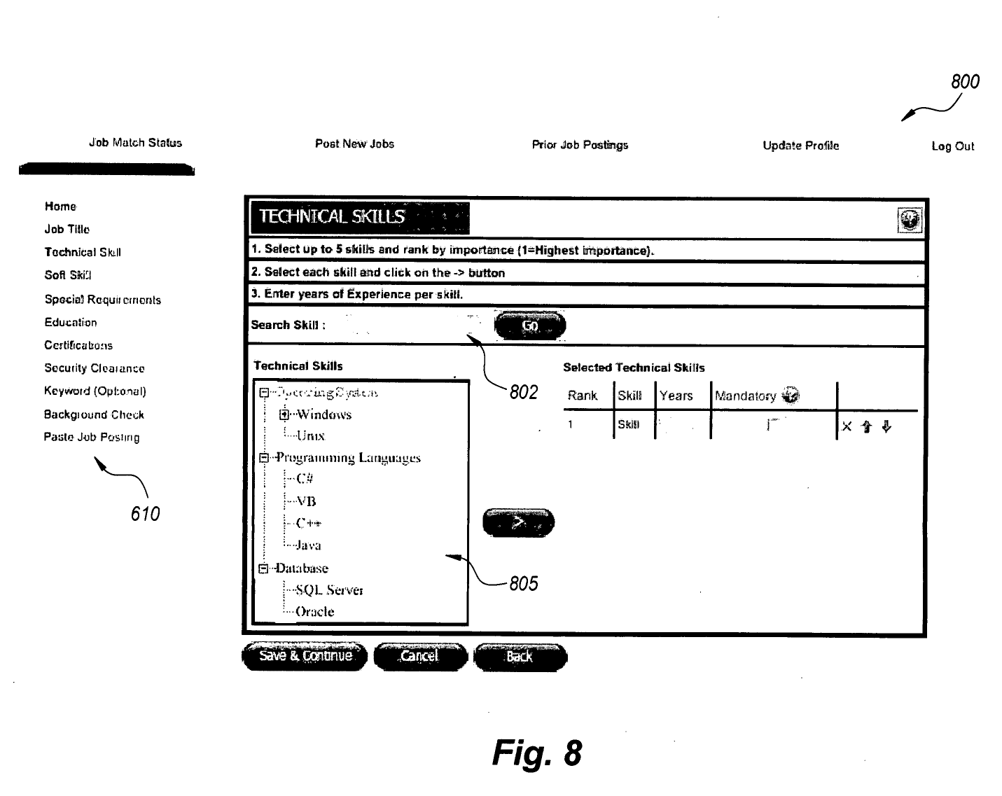

As shown in FIG. 5A, at steps 505, 510, 515 and 520, once an employer selects a job title, a technical skill template is provided. As shown in FIG. 8, the technical skills template 800 has a search entry field 802 and technical skill selection list 805. At step 525 the employer can select up to five skills (the number is system configurable) via, e.g., drag and drop, click and enter, and the like, using predefined templates for a specific market segment. The system 100 ranks the employer selections according to the order in which the skills were selected. The “Next” or “Right Arrow” button allows the employer to move to the next matching category.

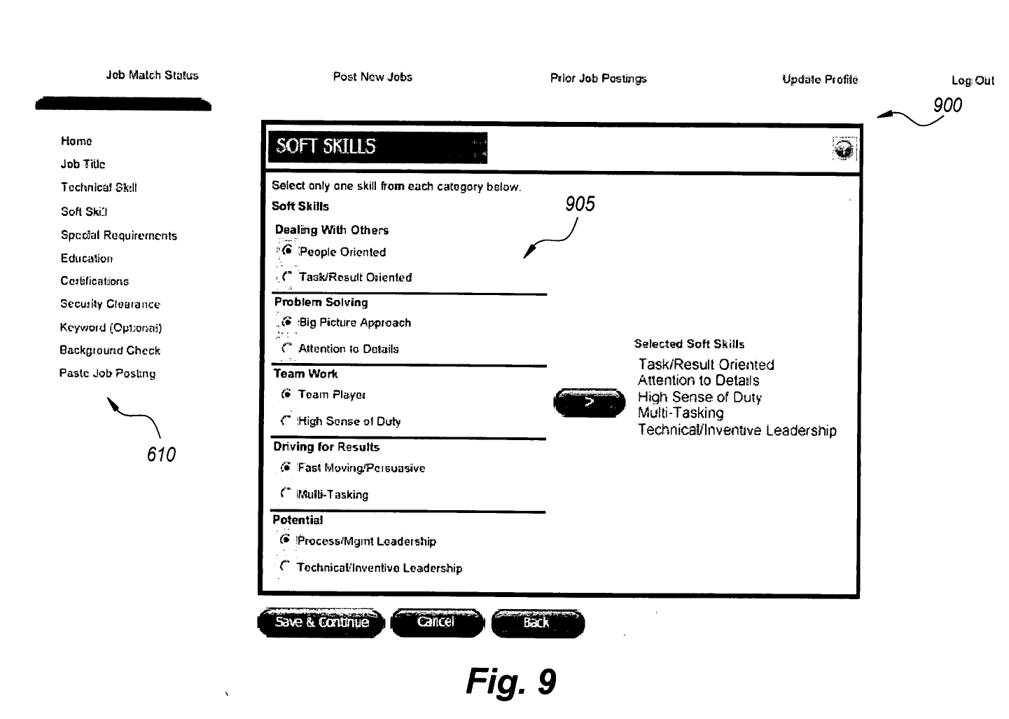

A soft skills selection list is presented at step 530. As shown in FIG. 9, the soft skills page 900 has a plurality of soft skills in display area 905. At step 535, the employer then selects from a list of key soft skills, using the predefined template presented at step 530. Two, or alternatively, any predetermined number of options, are given under each key skill; the employer selects only one from each category. The order and ranking of the soft skills are not important in this case.

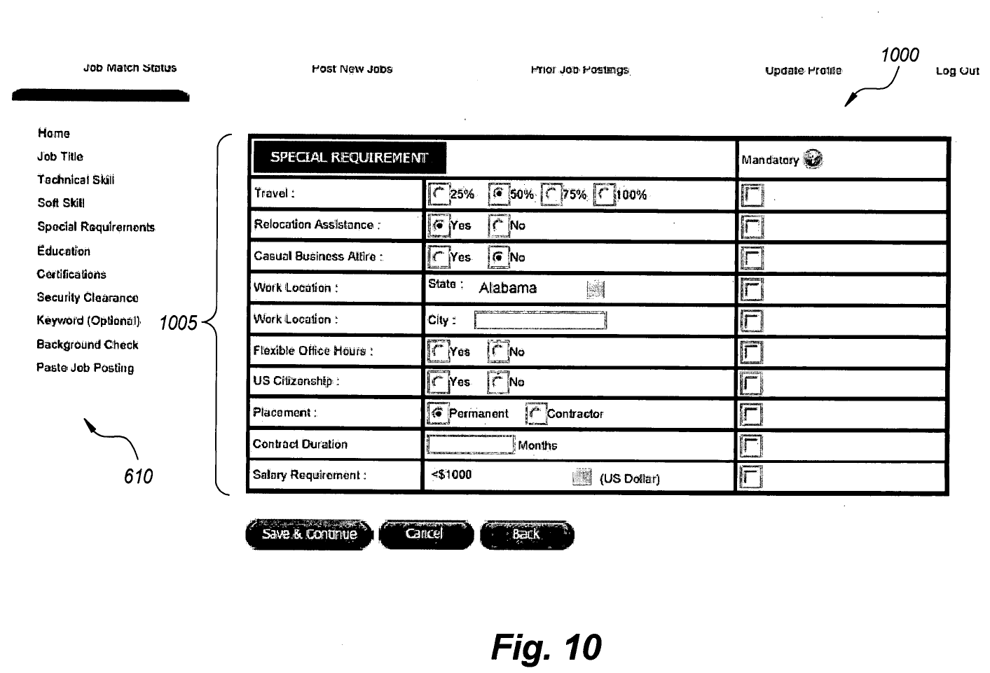

At step 540 the employer is provided with a “special requirements” template. As shown in FIG. 10, the special requirements template 1000 displays a plurality of special requirements 1005. At step 545 the employer can specify special requirements for a job position including travel, relocation, work permission, citizenship, work hours flexibility, required attire, salary requirements, and the like.

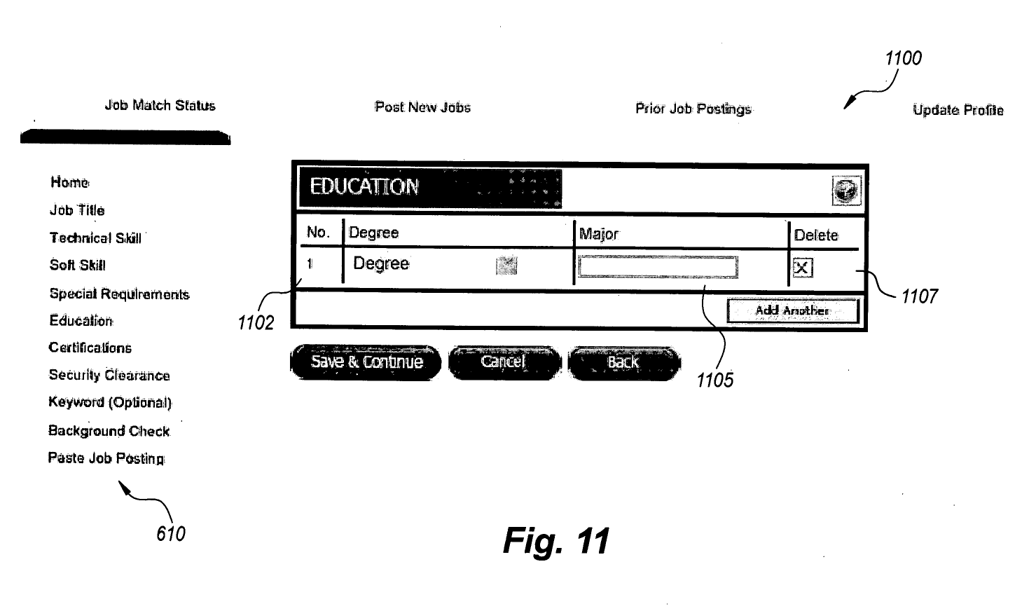

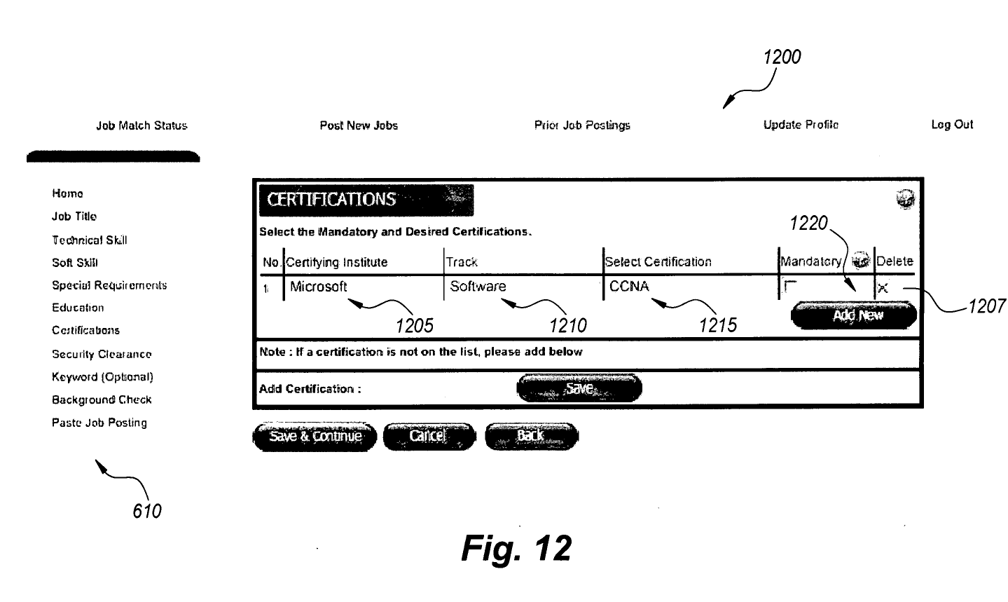

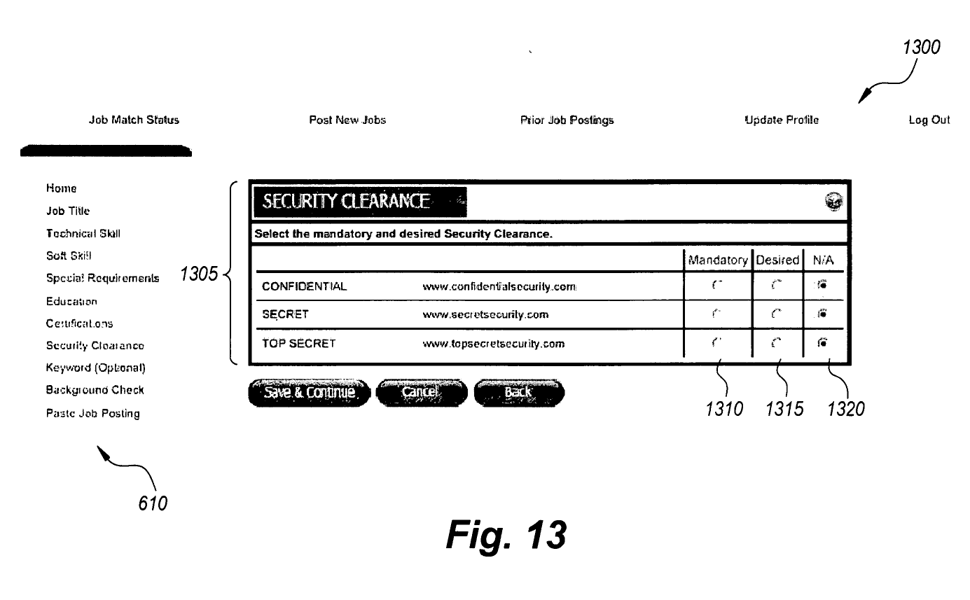

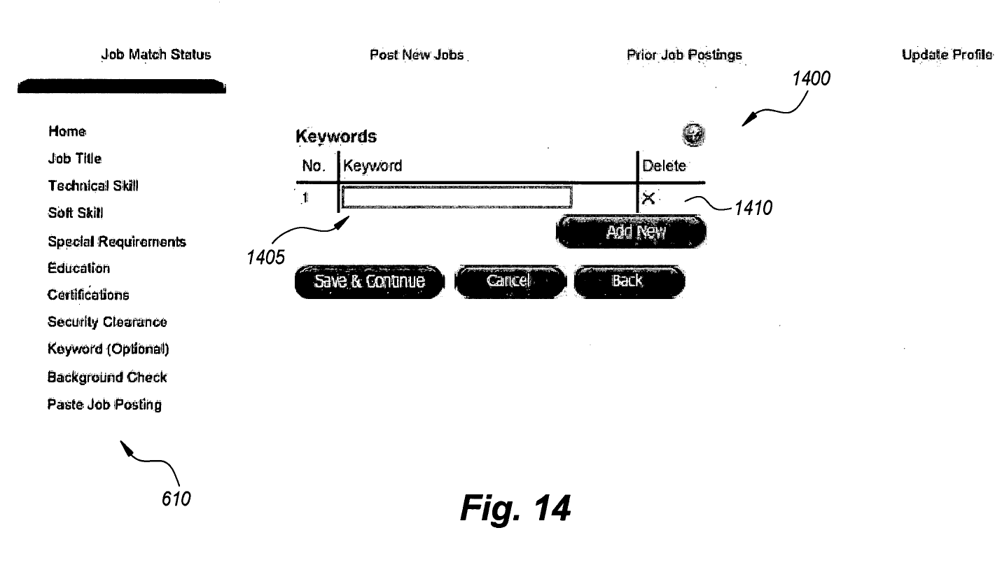

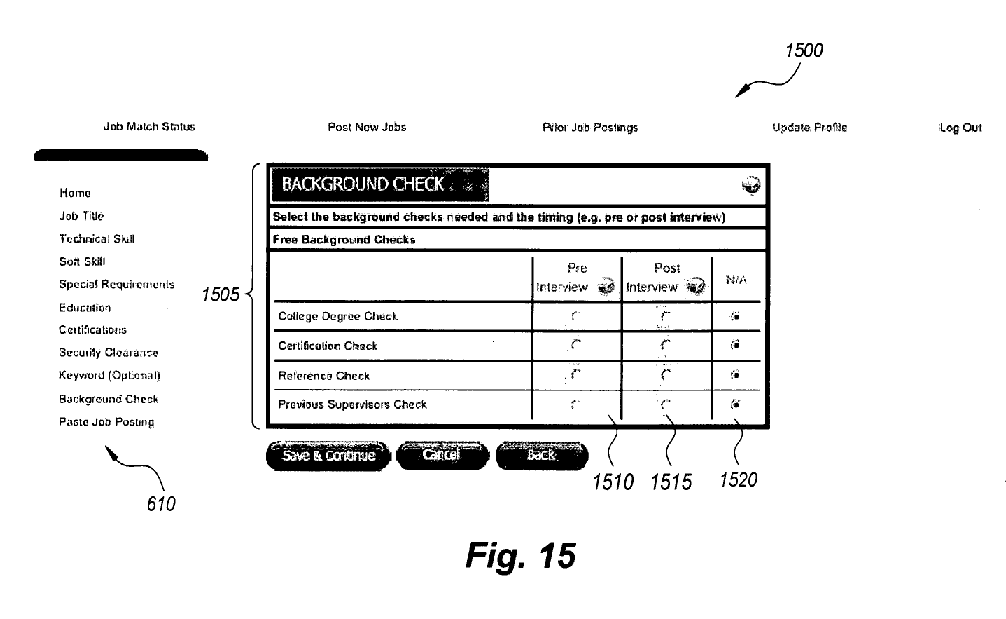

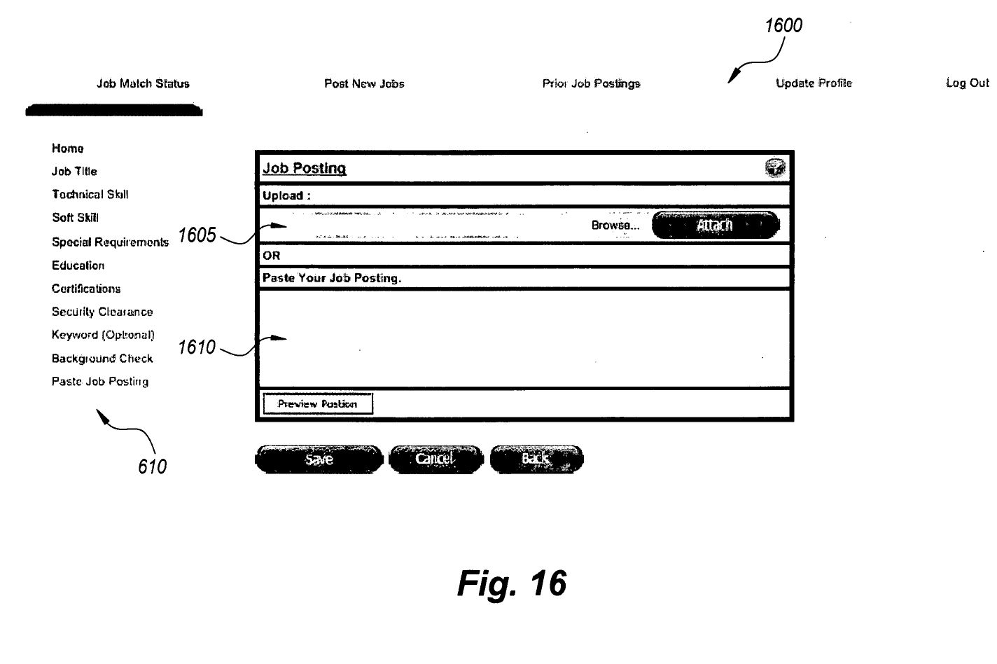

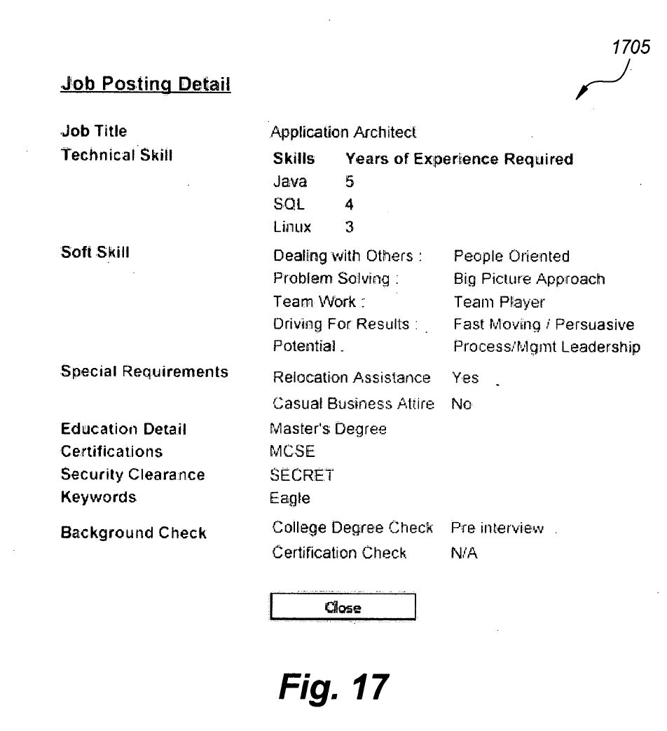

As shown in FIGS. 5A-5B, Education (steps 550 and 555), Certification (steps 560 and 565), Security Clearance (steps 570 and 575), Keyword (steps 580 and 582), and Background Check (steps 584 and 586) templates drive the employers to select requirements tailored for a specific market segment. FIG. 11 shows the Education template 1100 that has a sequence field 1102, a Degree and Major entry field 1105, and a delete field 1107. FIG. 12 shows the Certifications template 1200 having a certifying institute field 1205, track field 1210 certification select field 1215, a mandatory requirements box 1220, and a delete field 1207. The security clearance template 1300 has a plurality of security clearances 1305 that can be selected, as well as a mandatory requirements selection column 1310, a “desired” selection column 1315, and a “N/A” column 1320. The keyword template 1400 has a keyword entry field 1405 and a delete field 1410. The background template 1500 has a plurality of background checks 1505, a pre-interview selection column 1510, a post interview selection column 1515 and a “N/A” selection column 1520. The job posting template 1600 has an upload field 1605 and a paste field 1610. A job posting detail page 1705 can display the details of all the requirements specified by the employer. At step 588 the job posting template is presented. At step 590 the employer can upload the open job information via the filled out job posting template. At steps 592 and 594 the employer profile can be reviewed and entered into the open jobs database 115 for initiation of the matching process. As discussed supra, the job candidates preferably have followed a similar path in which they have filled out the job candidate templates.

The predefined employer and candidate templates capture important job position requirements in a streamlined manner in order to provide an abbreviated input process on the part of employers and candidates in which users can enter their information in an average of ten minutes or less. Additionally the system does not require information that may not be readily available, such as a prewritten job posting, company size description or financial profile.

The employer can input a few skills and do a quick search for a job match. This is possible since the templates are specially designed, (preferably the templates do not present questionnaire style questions, but rather present selectable lists of items), are pre-populated, and easy to modify/customize or leave “as is” for a quick job match.

The employee candidate profiles 405 or candidate initiated change/verification data 410, which both contain skills and experience data, are utilized by a matching engine having the capability, as shown at step 415, to compare all candidate and open job profiles residing in their respective databases 110 and 115, thus quickly performing a complete match of the candidate profile against the available job positions in the system 100.

The matching engine applies a unique matching logic to identify candidates with the best fit for a particular job opening. The matching logic categories include the Job Title, technical skills, soft skills, Mandatory Requirements, Special Requirements, Education, Certification, Security Clearance, Keywords and Background Checks.

According to the present invention, the matching logic is designed to eliminate candidates who don't meet all the mandatory requirements of the job position. The matching logic of the system 100 processes the template filters in the following order: first, applying the mandatory requirements template for candidate elimination; second, applying the special requirements template for candidate elimination; third, applying the technical skills template for candidate elimination; fourth, applying the soft skills template for candidate elimination; fifth, applying the education template for candidate elimination; and, if not previously done, sixth, applying the upfront background verifications template for candidate elimination. As an option of the system 100, background verifications filter can be applied before the other aforementioned filters are applied in order to quickly eliminate an unsuitable candidate, e.g., a candidate with an unresolved criminal history. As shown at steps 420, 425, 435, and 430, if the mandatory requirements are met, then an attempt is made to match the technical skills. If the technical skills or mandatory skills are not met, the candidate is eliminated from consideration for the open job requirement.

As shown at steps 445 and 450, technical skill score values are assigned, and a computer score based on candidate rank and employer rank is computed for each matched skill. At step 455 soft skills and special requirements are matched. At steps 460 and 465, soft skill and special requirements score values are assigned, and for each matched skill or special requirement, points corresponding to the score values are cumulatively assigned to the candidate score. Candidate background verification status is checked at step 470. At steps 475 and 477 a background verification score value is assigned and points based on the assignment are cumulatively added to the candidate score. At steps 479 and 480 a keyword score value is assigned, and for each matched keyword points are cumulatively added to the candidate score. At steps 481 and 485, a total candidate score is computed and stored. At step 490 candidate scores are compared and ranked accordingly. At step 495 a candidate match report is generated and the employer is alerted.

The template filter results are combined with the ranking of job skills by candidate and employer in order to uniquely establish high quality matches in the system 100. The system 100 assigns points to each matching category and its attributes. The point values are configurable at the system or position level; thus, the matching and scoring systems can be customized to the employer's needs. The assignment of points for technical skills is based on both the ranking and matching of skills. The keywords and keyword searches are also scored and are tied into the matching and scoring system. Match scores are generated and candidates can only view job openings for which they are selected as top candidates.

For any of the job candidates, until a match is generated, the candidate cannot view job/employer profile information held by the system. Additionally, no employer can view a job candidate's profile information held by the system until the employer is authorized by the job candidate.

A quality reviewer/analyzer is provided to review and analyze selections generated by the match engine. The reviewer/analyzer has inputs to the match engine comprising candidate types, candidate profiles, position requirements, employer feedback after a hire, and the like, that can refine the match-generating processes in order to improve quality of matching results through a consistent business intelligence process.

To further enhance and expedite the matching process, the present invention provides the opportunity for a candidate to include a personal video clip with his/her resume allowing for an introduction of the candidate to prospective employers, highlighting specific strengths and delivering key messages.

Moreover, this feature allows an employer to meet a candidate prior to an interview and to gain an initial sense for the candidate's personal style and presence. An upload of the video clip is provided as an option when a candidate creates his/her profile. Alternatively, the candidate can paste a link to a personal web site or public hosting web site.

As with all personal information, the present invention allows the candidate to control access to his/her personal video clip. According to the present invention, when the system 100 determines that a candidate is a match for a job listing, the candidate is contacted to authorize the release of his/her personal information, including the video clip, to the specific employer(s).

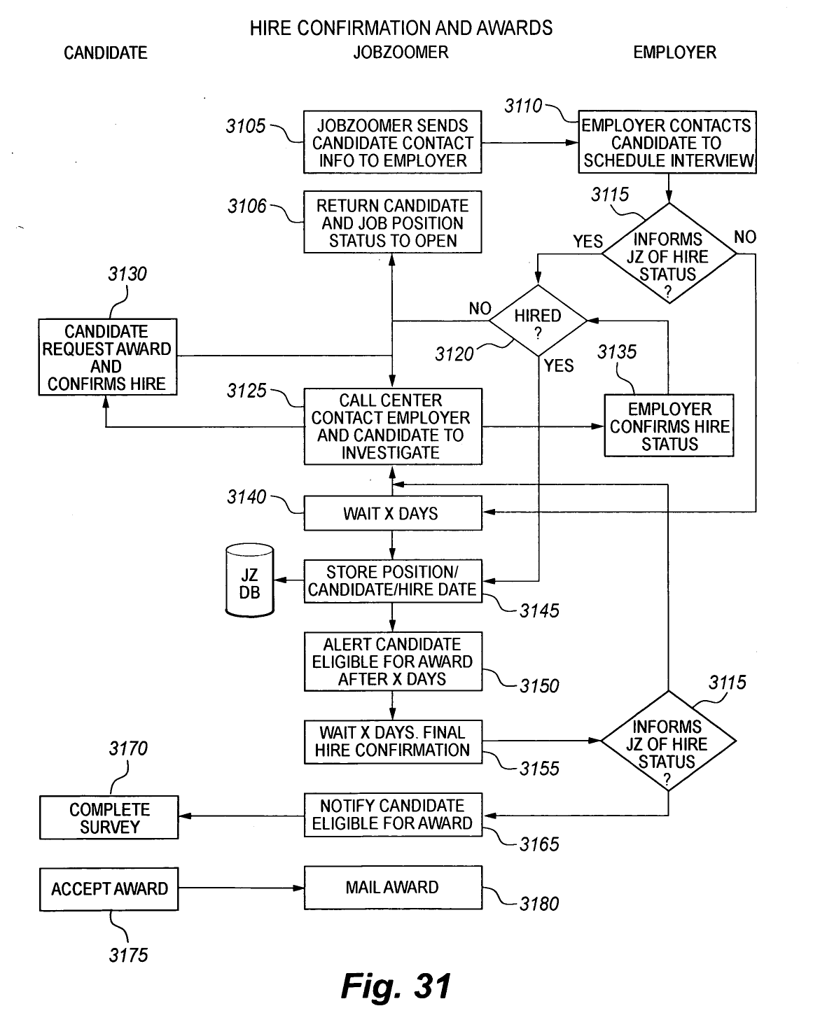

The system 100 provides the capability to offer reward programs, including a “Got Hired” Prize and a “Referral” Prize. As shown in FIG. 31, candidate contact information is sent to the employer at step 3105. At step 3110 the employer contacts the candidate to schedule an interview. At step 3115 employer informs system of candidate hire status. At step 3120, if the candidate was not hired, the candidate and open job status are returned to open at step 3106. The candidate requests award and confirms hire at step 3130. At step 3125 the call center contacts the employer and candidate to investigate. At step 3135 the employer confirms hire status. At step 3140 a predetermined time period is allowed to elapse. At step 3145 the job and candidate hire date are entered into the database. At step 3150 the candidate is alerted as being eligible for award after a predetermined time period. At step 3155 a final hire confirmation is performed. At step 3160, if the confirmation was successful, then the candidate is notified for award eligibility at step 3165. At step 3170 a survey is completed. At step 3175 the award is accepted. At step 3180 the award is mailed to the candidate. As candidates get hired, a “got hired” reporting option is provided on the system web site. Once verified, e.g., by proof that the candidate new employee has received a salary payment from the employer, the candidate qualifies for a “Got Hired” Prize.

Similarly, if a new candidate indicates a current user of the system 100 referred the candidate, the referrer is qualified by the system 100 to be eligible for a “Referral” Prize (one time prize per each new candidate).

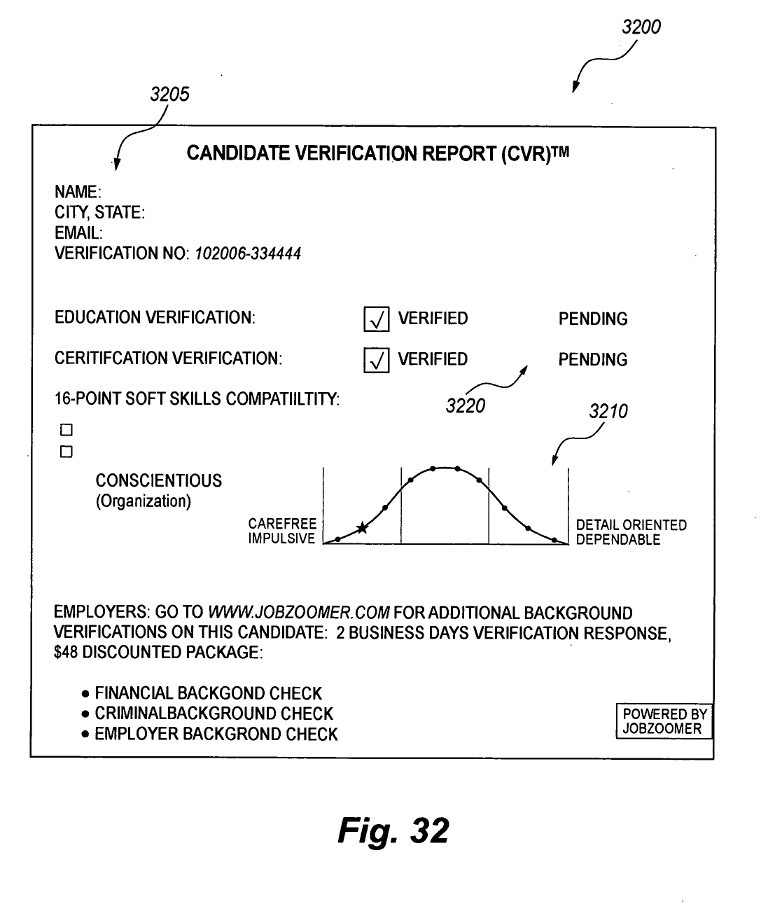

Optionally, as shown in FIG. 32, the system 100 can create a candidate verification report 3200. The verification report 3200 comprises candidate personal information 3205, e.g., Name, City, State, Email and a verification number. Verification status is displayed in screen area 3220. A skills compatibility indicator 3210 may also be provided.

It is to be understood that the present invention is not limited to the embodiment described above, but encompasses any and all embodiments within the scope of the following claims.

We claim:

1. A computer-implemented method of matching candidates and employers, comprising the steps of:
requiring job candidates to enter their profile data into a candidate database, the profile data being formed from data comprising selections by the candidate from predefined lists of skills, wherein the selected skills are ranked according to the order of selection by the candidate;
requiring employers to enter profile information about their open job requirements into an employer database;
generating match scores based on a comparison between the candidate profiles and the open job profiles;
identifying candidates with the best fit for a particular job opening based on the match scores;
permitting candidates to view only the job openings for which they have been selected as top candidates; and
permitting employers to view only the profiles of candidates who have authorized them to do so.

2. The method of matching candidates and employers according to claim 1, wherein the step of requiring job candidates to enter their profile data into a candidate database further comprises the step of providing pre-defined templates which the job candidate must use for the profile data entry, the pre-defined templates being provided for key position requirements to thereby significantly improve matching quality, matching speed, and ease of use for both the employers and the candidates.

3. The method of matching candidates and employers according to claim 2, wherein the step of providing pre-defined templates further comprises providing the capability to customize the templates to make suitable for a particular employer open job requirement.

4. The method of matching candidates and employers according to claim 2, wherein the step of providing pre-defined templates further comprises the steps of:
providing a mandatory requirements template;
providing a special requirements template;
providing a technical skills template;
providing a soft skills template; providing an education template; and
providing an upfront background verifications template.

5. The method of matching candidates and employers according to claim 4, wherein a background check based on candidate data entry to the upfront background verification template can be performed to eliminate candidates before any other candidate elimination filtering is performed.

6. The method of matching candidates and employers according to claim 4, wherein the step of generating match scores further comprises in the cardinal order listed, the steps of:
first, applying the mandatory requirements template to eliminate candidates;
second, applying the special requirements template to eliminate candidates;
third, applying the technical skills template to eliminate candidates;
fourth, applying the soft skills template to eliminate candidates;
firth, applying the education template to eliminate candidates; and
if not previously done, sixth, applying the upfront background verifications template to eliminate candidates.

7. The method of matching candidates and employers according to claim 1, further comprising the steps of:
reviewing and analyzing in a continuous manner quality and parameters of job matches made; and
refining processes associated with the step of generating match scores in order to improve the quality of matching results, the refining being based on output data from the quality reviewing and analyzing.

8. A system for matching candidates and employers, comprising:
at least one computing device being in operable communication with at least one mass storage device;
a candidate database and an open jobs database, the databases being held in the at least one mass storage device;
at least one user interface in operable communication with the at least one computing device, the user interface having means for requiring candidates using the system to enter profile data into the candidate database, the profile data being formed from data comprising selections by the candidate from predefined lists of skills, wherein the selected skills are ranked according to the order of selection by the candidate;
the user interface further having means for requiring employers to enter profile information about their open job requirements into the open jobs database;
means for generating match scores based on a comparison between the candidate profiles and the open job profiles;
means for identifying candidates with the best fit for a particular job opening based on the match scores;
means for permitting candidates to view only the job openings for which they have been selected as top candidates; and
means for permitting employers to view only the profiles of candidates who have authorized them to do so.

9. The system for matching candidates and employers according to claim 8, further comprising: means for providing pre-defined templates, which the job candidate must use for the profile data entry.

10. The system for matching candidates and employers according to claim 9, further comprising:
means for providing a mandatory requirements template;
means for providing a special requirements template;
means for providing a technical skills template;
means for providing a soft skills template;
means for providing an education template; and
means for providing an upfront background verifications template.

11. The system for matching candidates and employers according to claim 10, further comprising: means for performing a background check based on candidate data entry to the upfront background verification template before any other candidate elimination filtering is performed.

12. The system for matching candidates and employers according to claim 10 wherein the means for generating match scores further comprises:
means for first applying the mandatory requirements template to eliminate candidates;
means for second applying the special requirements template to eliminate candidates;
means for third applying the technical skills template to eliminate candidates;
means for fourth applying the soft skills template to eliminate candidates;
means for fifth applying the education template to eliminate candidates; and
means for conditionally applying sixth the upfront background verifications template to eliminate candidates if it has not already been applied.

13. The system for matching candidates and employers according to claim 8, wherein the user interface comprises at least one web page made available from a web site for presentation to a user.

14. A method of matching candidates and employers performed by a machine executing a program of instructions tangibly embodied in a program storage device readable by the machine, the method comprising the steps of:
requiring job candidates to enter their profile data into a candidate database, the profile data being formed from data comprising selections by the candidate from predefined lists of skills, wherein the selected skills are ranked according to the order of selection by the candidate;
requiring employers to enter profile information about their open job requirements into an employer database;
generating match scores based on a comparison between the candidate profiles and the open job profiles;
identifying candidates with the best fit for a particular job opening based on the match scores;
permitting candidates to view only the job openings for which they have been selected as top candidates; and
permitting employers to view only the profiles of candidates who have authorized them to do so.

15. The method of matching candidates and employers according to claim 14, wherein the step of requiring job candidates to enter their profile data into a candidate database further comprises the step of providing pre-defined templates which the job candidate must use for the profile data entry, the pre-defined templates being provided for key position requirements to thereby significantly improve matching quality, matching speed, and ease of use for both the employers and the candidates.

16. The method of matching candidates and employers according to claim 15, wherein the step of providing pre-defined templates further comprises: providing the capability to customize the templates to make suitable for a particular employer open job requirement.

17. The method of matching candidates and employers according to claim 15, wherein the step of providing pre-defined templates further comprises the steps of:
providing a mandatory requirements template;
providing a special requirements template;
providing a technical skills template;
providing a soft skills template;
providing an education template; and
providing an upfront background verifications template.

18. The method of matching candidates and employers according to claim 17, wherein a background check based on candidate data entry to the upfront background verification template can be performed to eliminate candidates before any other candidate elimination filtering is performed.

19. The method of matching candidates and employers according to claim 17, wherein the step of generating match scores further comprises in the cardinal order listed, the steps of:
first, applying the mandatory requirements template to eliminate candidates;
second, applying the special requirements template to eliminate candidates;
third, applying the technical skills template to eliminate candidates;
fourth, applying the soft skills template to eliminate candidates;
fifth, applying the education template to eliminate candidates; and
if not previously done, sixth, applying the upfront background verifications template to eliminate candidates.

20. The method of matching candidates and employers according to claim 14, further comprising the steps of:
reviewing and analyzing in a continuous manner quality and parameters of job matches made; and
refining processes associated with the step of generating match scores in order to improve the quality of matching results, the refining being based on output data from the quality reviewing and analyzing.
